(19) United States
(12) Patent Application Publication
(10) Pub. No.: US 2024/0000045 A1
(43) Pub. Date: Jan. 4, 2024

(54) LIVESTOCK MONITORING

(71) Applicant: COMMONWEALTH SCIENTIFIC AND INDUSTRIAL RESEARCH ORGANISATION, Australian Capital Territory (AU)

(72) Inventors: Jace GALVIN, Australian Capital Territory (AU); Aaron INGHAM, Australian Capital Territory (AU); Philip VALENCIA, Australian Capital Territory (AU); Volkan DEDEOGLU, Australian Capital Territory (AU); Nick VAN BEEST, Australian Capital Territory (AU); Reza ARABLOUEI, Australian Capital Territory (AU); Guido GOVERNATORI, Australian Capital Territory (AU)

(21) Appl. No.: 18/255,193

(22) PCT Filed: Nov. 30, 2021
(86) PCT No.: PCT/AU2021/051430

§ 371 Date: May 31, 2023

(30) Foreign Application Priority Data
Dec. 1, 2020 (AU) 2020904456

(51) Int. Cl. A01K 29/00; G06Q 50/02

(52) U.S. Cl. CPC A01K 29/005; G06Q 50/02; G06Q 2220/00

(57) ABSTRACT

This disclosure relates to a system for livestock monitoring. Animal monitoring devices, mounted on animals, collect accelerometer data of parts of the animals. The devices classify the accelerometer data into one of multiple animal behaviours, to create behaviour classification data. Gateway devices receive the behaviour classification data from the animal monitoring devices, responsive to the one or more of the multiple animal monitoring devices being within a communication range of the gateway device. The gateway devices also obtain sensor data in relation to the animals that is measured independent from the animal behaviours. A rules engine, located remotely from the animals, determines compliance of the animal behaviours with predetermined rules, wherein the behaviours and sensor data are used as variable values in determining the compliance.

### CROSS-REFERENCE TO RELATED APPLICATIONS

The present application claims priority from Australian Provisional Patent Application No 2020904456 filed on 1 Dec. 2020, the contents of which are incorporated herein by reference in their entirety.

### TECHNICAL FIELD

This disclosure relates to monitoring livestock. In particular, but not limited to, this disclosure relates to sensors and communication networks for monitoring livestock.

### BACKGROUND

Trust in food products has become an important concern with the advancement of globalised food supply chains. A number of providers have gained a reputation for high-quality food products but there are also competitors who's claims on product quality remains dubious. In particular for livestock products, such as meat and especially beef, there is a need to provide a provenance solution that enables verification of beef quality. Since that quality depends on the conditions for an individual animal, it would be ideal to have record for each individual animal.

The problem with livestock, however, is that animals graze across a large area of land, which may not have network connectivity everywhere. Especially in remote areas, such as on large Australian cattle farms, a wireless network is available at or near farm buildings, but at places where animals graze, connectivity is not available.

Further, sensors that operate under harsh conditions are prone to damage and other effects that lead to inaccurate sensor readings. It is then difficult to determine whether a particular sensor provides accurate or inaccurate data.

Therefore, there is a need for a food provenance solution that considers measurements from individual animals but can operate without permanent network connectivity between each animal and an aggregating server.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

A system for livestock monitoring comprises:
multiple animal monitoring devices, each configured to:
   be mounted on respective animals,
   collect accelerometer data of one or more parts of the animals,
   classify, by a processor integrated with each of the animal monitoring devices, the accelerometer data into one of multiple animal behaviours, to create behaviour classification data;
one or more gateway devices configured to:
   receive the behaviour classification data from one or more of the multiple animal monitoring devices, responsive to the one or more of the multiple animal monitoring devices being within a communication range of the gateway device, and
   obtain sensor data in relation to the animals that is measured independent from the animal behaviours; and
a rules engine, located remotely from the animals, configured to determine compliance of the animal behaviours with predetermined rules, wherein the behaviours and sensor data are used as variable values in determining the compliance.

In some embodiments, the one or more gateway devices are configured to store the behaviour classification data and the sensor data on a first blockchain.

In some embodiments, the first blockchain is a private blockchain.

In some embodiments, calculating the score indicative of the reliability of the animal behaviours in light of the sensor data is performed by a smart contract on the first blockchain.

In some embodiments, the first blockchain is configured to store a hash value of each of multiple blocks; and the system further comprises a second blockchain that is configured to store the hash values of the first blockchain to establish a cryptographic link to the first blockchain.

In some embodiments, classifying by the processor integrated with each of the animal monitoring devices, the accelerometer data into one of multiple animal behaviours, to create behaviour classification data, is based on a linear classifier.

In some embodiments, the linear classifier comprises a soft-max classifier.

In some embodiments, classifying comprises filtering the accelerometer data using a low-pass filter.

In some embodiments, classifying is based on frequency features of the accelerometer data.

In some embodiments, the one or more gateway devices are further configured to obtain weather data; and the weather data is used as variable values in determining compliance by the rules engine.

In some embodiments, each of the multiple animal monitoring devices is further configured to determine compliance, based on data collected by that animal monitoring device, with animal rules.

In some embodiments, each of the multiple animal monitoring devices is further configured to collect sensor data from sensors integrated with that animal monitoring device.

In some embodiments, the sensor data comprises geographic location data from a satellite or terrestrial navigation system.

In some embodiments, the one or more gateway devices are further configured to calculate a score indicative of a reliability of the animal behaviour in light of the sensor data and the rules engine is configured to determine compliance such that the behaviours are related to the score.

In some embodiments, the system further comprises an aggregator configured to receive behaviour classification data for individual animals and output composite data.

In some embodiments, the composite data comprises one or more of:
composite data for a group of animals;
composite data over a period of time for one or more animals; and
composite data over a period for weather data.

In some embodiments, the rules engine is further configured to determine animal data other than behavioural classification data for individual animals, and the aggregator is further configured to receive the animal data other than behavioural classification data to determine the output composite data.

In some embodiments, the rules engine is configured to
access animal specific rules to determine the animal data other than behavioural classification data; and
access general rules to determine compliance based on the output composite data for the group of animals.

A method for livestock monitoring comprises:
collecting, by multiple animal monitoring devices mounted on respective animals, accelerometer data of one or more parts of the animals;
classifying, by a processor integrated with each of the animal monitoring devices, the accelerometer data into one of multiple animal behaviours, to create behaviour classification data;
receiving, by a gateway device, the behaviour classification data from one or more of the multiple animal monitoring devices, responsive to the one or more of the multiple animal monitoring devices being within a communication range of the gateway device, and;
obtaining sensor data in relation to the animals that is measured independent from the animal behaviours; and
determining, by a rules engine located remotely from the animals, compliance of the animal behaviours with predetermined rules, wherein the behaviours and sensor data are used as variable values in determining the compliance.

A method for livestock monitoring comprises:
responsive to the one or more of the multiple animal monitoring devices being within a communication range, receiving behaviour classification data from multiple animal monitoring devices, the behaviour classification data being indicative of classifications derived from accelerometer data of one or more parts of the animals;
obtaining sensor data in relation to the animals that is measured independent from the animal behaviours; and
determining compliance of the animal behaviours with predetermined rules, wherein the behaviours and sensor data are used as variable values in determining the compliance.

### BRIEF DESCRIPTION OF DRAWINGS

FIG. 1 illustrates a cattle farm.

FIG. 2 illustrates a method for livestock monitoring.

FIG. 3 shows the accelerometer readings concatenated over all annotated periods and all animals for each spatial axis, i.e., x, y, and z.

FIG. 4 illustrates the normalized histograms of the accelerometer readings of all 10-second windows for each behavior class and axis.

FIG. 5 illustrates the frequency response of the first-order high-pass Butterworth filter with different values of its parameter.

FIG. 6: The normalized histograms of the filtered accelerometer readings of all 10-second windows for each behavior class and axis when γ=0 (a)-(c) and γ=0.5 (d)-(f).

FIG. 7: The amplitude density functions of the annotated accelerometer readings for each behavior class and axis averaged over all 10-second windows.

FIG. 8: The overall classification accuracy of the softmax algorithm for different combinations of γ₁ and γ₂.

FIG. 9: The ANOVA F-value and the estimated mutual information between the features and the corresponding class labels together with the feature importances reported by an RF classifier.

FIG. 10: The projection of the datapoints of the resting behavior class and the outliers identified using the RCF algorithm onto the plane of two corresponding principle components.

FIG. 11: Visualizations of the cattle behavior dataset using the tSNE algorithm with two different values for the perplexity parameter.

FIG. 12: The learned decision-tree classifier.

FIG. 13: The confusion matrix of cattle behavior classification when using the softmax algorithm with 5-fold stratified cross-validation.

FIG. 14: The predicted time spent performing each behavior on every calendar day during the trial for two cattle.

FIG. 15: The predicted daily pattern of behaviors for two cattle on two different days. The hour zero on the x axis corresponds to midnight. The legend of behaviors is the same as that of FIG. 14 and is not shown to avoid cluttering.

FIG. 16: The proposed layered trust architecture.

FIG. 17: Two-tiered network structure. Data is collected by IoT devices connected to gateway nodes, which maintain the blockchain overlay network.

FIG. 18: The block structure generated by a gateway node.

FIG. 19 illustrates the probability of not detecting any invalid transactions in a block with Txₜₒₜₐₗ=100 transactions for Nᵥₐₗ=1, 5, 20.

FIG. 20: Number of validators required for a target probability threshold of not detecting an invalid transaction in a block as a function of number of validated transactions by each validator.

FIG. 21 illustrates a simulation scenario.

FIG. 22 illustrates RSSI values of ROOM1 sensor nodes (RSSI(d₀)=−44.8 dB, d₀=1 m, and σ=1.

FIG. 23 illustrates trust values of sensor nodes assigned by the gateway node.

FIG. 24: The number of malicious nodes |Sₘ| that the data trust module can tolerate for Tconfₘ=1 and K=100.

FIG. 25 illustrates Invalid block detection performance and reputation evolution for a simulated scenario (δ=0.03).

FIG. 26 illustrates latency of the proposed trust architecture compared to a baseline blockchain based scheme.

FIG. 27 illustrates a layered computer architecture for livestock monitoring.

### DESCRIPTION OF EMBODIMENTS

As set out above, there is a need for verifiable provenance and monitoring of individual animals, such as cattle. However, devices that the animals can wear have only limited functionality in terms of wireless networking and storage space due to their small size, limited battery capacity and required robustness.

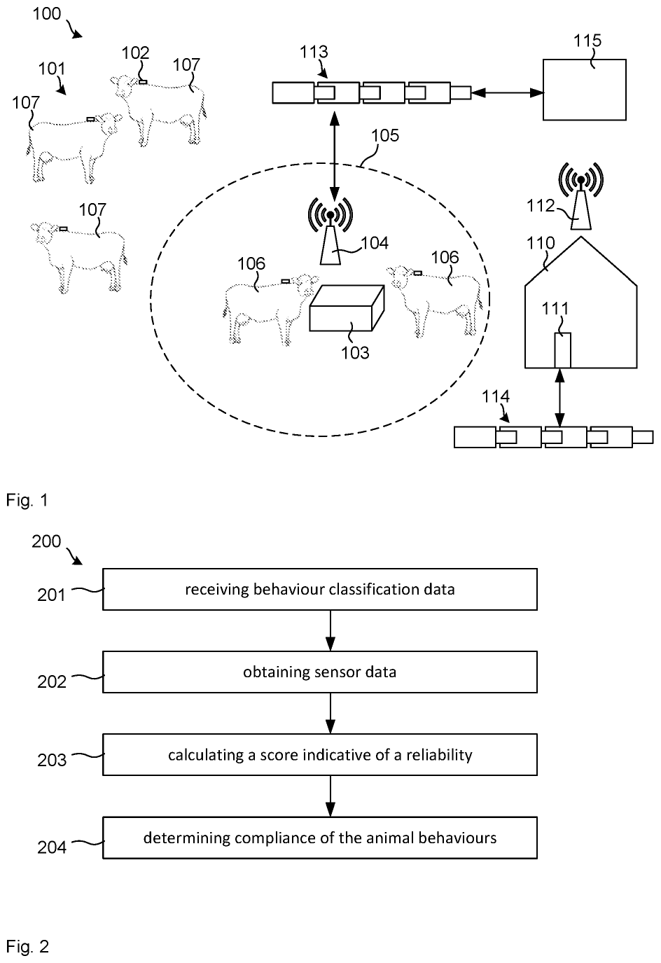

FIG. 1 illustrates a cattle farm 100, comprising a herd of cattle 101 and a farm building 102. Each of the animals carries a monitoring device, as shown at 102. Monitoring device 102 comprises a computer system including a processor, program memory and data memory, as well as a movement sensor, such as an acceleration sensor. The movement sensor measures acceleration in three-dimensions and provides the measured data to the processor.

While it is possible to store the acceleration data on the monitoring device 102, the resulting amount of data may become larger than the local memory capacity. Further, transmitting this data over a low-bandwidth network connection may be impractical due to long transmission time and packet errors. Therefore, the processor on the monitoring device classifies the movement data into cattle behaviours, such as resting, walking, grazing, drinking, ruminating and being transported.

Cattle farm 100 further comprises fixed infrastructure, such as water trough 103. At that fixed infrastructure, it is feasible to install network connectivity, such as wireless access point 104, providing wireless data access within a communication range 105. As can be seen, two animals 106 are located within the communication range 105, while further three animals 107 are outside communication range 105.

While the animals 106 are within communication range 105, their monitoring device can transmit monitoring data to wireless access point 104. In particular, the monitoring device transmits behaviour classifications for multiple time stamps, that is a time recording of behaviours, to the access point 104. Transmitting the behaviour data requires significantly less bandwidth that transmitting the full recorded acceleration data. Since wireless access point 104 operates as a gateway to a data network, it is also referred to as a gateway node 104.

Gateway node 104 may further collect additional data in relation to animals 106. Gateway node 104 may collect this data by way of analysing network metrics. For example, gateway node 104 determines that monitoring devices of animals 106 are within range 105, which means the animals 106 are located nearby. The gateway node may comprise further sensors, such as a camera, infrared sensors, and the like to capture further data. In particular, gateway node 104 may collect data that is indicative of a presence of one of the animals 106. Therefore, the additional data can serve to corroborate the data from the monitoring device. More particularly, the monitoring device 102 may also record GPS data and process it by determining whether the animal is in proximity to the water trough 103, for example. Gateway node 104 can then compare the proximity data from the monitoring device 102 to the additional data captured by the gateway node 105.

Gateway node 104 can then calculate a score that indicates whether both match. This score may also be referred to as a “trust score”. If the monitoring device 102 indicates that the animal 106 was in close proximity to the water trough, and the gateway node 104 registered that the monitoring device was within communication range 105, gateway node 104 assigs a high score, such as 1. If both data points do not match, gateway node 104 assigns a low score, such as 0 to that data point.

In one example, gateway node 104 stores the data from monitoring device 102 and the additional data on a private blockchain 113. In that case, the calculation of the trust score can be implemented using smart contracts on the private blockchain 113. As a result, the data itself is immutable and the calculation of the trust score can be verified at any time. It should also be noted that in most examples there are multiple gateway devices 104, which each have access to the private blockchain 113. As a result, the multiple gateway devices 104 store their data concurrently on blockchain 113 and each gateway device 104 has access to the data from the other gateway devices. This way, a distributed data set is created, which allows compliance checking and other calculations at any point within the network, such as anywhere on and off the farm 100. It is also possible that the actual raw data is stored in a distributed database, which is a computer network where information is stored on more than one node, potentially in a replicated fashion. Examples are Bigtable, Couchbase, Dynamo and Hypertable. The private blockchain may then only store a reference to the corresponding dataset stored on the distributed database and a hash of that data set. This has the advantage that less raw data is stored in the blockchain, which improves performance of the blockchain, while at the same time, enabling auditing at a later stage since the raw data can always we obtained. Where the data is replicated across multiple nodes, the data is also protected against loss or corruption of individual nodes, which makes the system more robust.

Cattle farm 100 further comprises a farm building 110 housing a server 111. The server 111 receives data from a second wireless access point 112, which in turn receives data from gateway node 104. This data, received by server 111 comprises behaviour data generated by the monitoring devices 102 as well as additional data generated by gateway node 104. Since the additional data generated by gateway node is indicative of the presence of an animal. Server 111 can store this data locally or rely on private blockchain 113 for a persistent ledger of records.

In some examples, behaviour data and sensor data are secret and should be treated as confidential. As a result, cryptography can be used to prevent outside attacks to reveal the secret data. To that end, there is also a public blockchain 114, which stores hash value or other audit information. This way, a specific data value can be audited on the private blockchain 113, but the data value itself does not need to be reveal. Instead, only the hash value is revealed. While it is practically impossible to calculate the original data from the hash value, it is possible to compare the hash value against the data stored on public blockchain 114. If both values match, the data is correct. If they do not, there is a difference between the purported data and the actual data, noting that the data stored on private blockchain is immutable. In one example, the public blockchain 114 stores the hash value of the behaviour data and/or sensor data while in other example, he public blockchain 114 stores the hashes of the blocks of the private blockchain 113. In the latter example, with blockchain hashes from private chain stored on public chain 114, there is a direct cryptographic link between the chains by way of their shared hashes.

Cattle farm 100 further comprises a logic engine 115, which obtains the data stored on private blockchain 113 or directly from server 111. In one example, the logic engine 115 comprises the SPINdle software as available from https://github.com/NICTA/SPINdle. The logic engine 115 converts the data into variable values, which may be Boolean values. The logic engine 115 has further stored a logic representation of policies, regulations or guidelines, where the variables of the logic representations include the same variables for which the values have been determined using the data from server 111. Consequently, rules engine 115 can evaluate the rules for those variable values and provide an output indicative of whether the policies, regulations or guidelines are met or violated.

The result is a single value for each animal. Advantageously, the result can be audited at any time against the data stored on the blockchain 113 such that it is practically impossible to tamper with the output value of the rules engine 115. Since the data from monitoring devices 102 and gateway node 104 are available instantly, logic engine 115 can provide a real-time indication of compliance. In that case, the logic engine does not take into account the trust values since the calculation by way of smart contracts may add a delay, which would make real-time indication impossible.

Here, the logic engine 115 is located remote from the animal. This means that the logic engine is a separate device from the animal in the sense that the animal can move away from the logic engine 115 and can potentially move to a place that is outside range 105 so that the logic engine relies on historical, stored data from monitoring device 102. Logic engine 115 does not necessarily be located far away from the animal but could be at a distance of 1 m, for example. While the logic engine 115 for the entire farm 100 is located remotely from the animals, there may be further instances of logic engines integrated into monitoring devices 102, which perform in-situ real-time compliance checking.

While logic engine 115 is shown in FIG. 1 to receive data that is stored in blockchain 113, it is equally possible that logic engine 115 receives the behaviour data and further sensor data directly from gateway device 104. To that end, logic engine 115 may be integrated with gateway device 104 in the sense that the binary is executed by the same processor or in the same computer system as the receiving and processing of behaviour data. In yet another example, the behaviour and sensor data may be uploaded into an IoT cloud analytics platform from where the logic engine 115 obtains the data. That platform may be Senaps from CSIRO (https://products.csiro.au/senaps/).

The compliance checking may be performed in real-time, such that compliance is determined as the behaviour data becomes available with minimum delay. The compliance output, such as a value of a Boolean variable for each of multiple points in time, is then provided separately from blockchains 113 and 114. Additionally, the trust score may be calculated in private blockchain 113 by execution of smart contracts, which may take longer than the compliance checking. For example, the trust calculation may take minutes while compliance checking takes seconds. However, real-time compliance is useful to give farmers and other operators the chance of early intervention. On the other hand, trust scores may only be required for retrospective auditing, so the added benefit of a blockchain based security may outweigh the disadvantage of a delay.

FIG. 2 illustrates a method 200 for livestock monitoring as performed by a computer system, such as gateway device 104 or a different computer system. The method commences responsive to the one or more of the multiple animal monitoring devices 102 being within a communication range 105 of the computer system. The computer system then receives 201 behaviour classification data from the multiple animal monitoring devices 102. As described above, the behaviour classification data is indicative of classifications derived from accelerometer data of one or more parts of the animals. Further details on the classification algorithm are provided below.

The computer system further obtains 202 sensor data in relation to the animals that is measured independent from the animal behaviours. As mentioned above, the sensor data may comprise camera data. The computer system may further receive or obtain weather data or other farm-related data and then calculate 203 a score indicative of a reliability of the animal behaviours in light of the sensor data. The details of this trust calculation are provided below. Finally, the computer system determines 204 compliance of the animal behaviours with livestock rules, wherein the behaviours are related to the trust score and are used as variable values in determining the compliance.

It is noted that the weather data and further farm-related data may also be used as variable values in the compliance calculation. For example, the weather data may comprise a temperature value and the rules may require certain conditions to be met above predefined temperatures. The weather data may be obtained by gateway device 104 via a satellite connection, and may be received as part of a broadcast communication from the satellite.

Further, monitoring devices 102 may comprise localisation sensors, such as GPS or terrestrial localisation sensors. Monitoring devices 102 may record the location over time and also transmit the recorded locations to the gateway device. In other examples, monitoring devices 102 only transmit the current location to the gateway device while the monitoring device 102 is within range 105.

In yet a further example, the monitoring device 102 has data connectivity through a satellite link. This may be a low bandwidth data link or an emergency link. There may also be a lightweight compliance engine embedded into the monitoring device, such that the location data can be processed in real time in-situ to determine compliance locally. This would enable making use of the location data without the need to store or transmit the location data over the low-bandwidth satellite data link. In the event of a non-compliance result, the monitoring device 102 can use the satellite data link as an emergency channel to send the current location with an emergency flag. This way, a geo-fencing functionality can be realised, where stolen or lost cattle can be identified and saved before it is too late.

Method 200 may be performed by the gateway device, which may be referred to as edge processing. In other examples, method 200 is performed remotely on a server, such as a cloud application. The connection to blockchain 113 may also be realised by gateway device 104 or by a server, such that either the gateway device 104 stores the behaviour and sensor data on blockchain 113 or sends that data to server 111, which then stores the received data on blockchain 113.

While examples herein relate to cattle, this disclosure equally applies to other domesticated animals raised in an agricultural setting, such as sheep, chicken, pigs, etc. to produce labour and commodities such as meat, eggs, milk, fur, leather, and wool.

The description below provides further details on the calculations performed. It is noted that when reference is made to ‘we’ performing a particular step, this means that this step can be performed by a computer system, either on the monitoring device 102, the gateway device 104, the server 111 or elsewhere.

### In-Situ Classification of Cattle Behavior Using Accelerometry Data

Monitoring and analyzing behaviors of individual livestock over large spatio-temporal scales can provide valuable information about changes in their baseline behavior. This information can in turn be used to measure animal health and performance allowing real-time management of resources in an optimal manner. The cost of gathering such information by relying solely on human labor can be prohibitive rendering it impractical or even impossible when large numbers of animals, spread over large areas, are to be monitored continuously. Wearable and networked sensor technologies offer a solution by enabling the automated collection and processing of the relevant data. Often, the sheer size and high frequency of data makes it inefficient or even infeasible to stream the data to some central storage/processing hub for analysis. Therefore, for sensor technologies to be successful at scale, the capability to extract knowledge from the data in real-time needs be integrated into the sensor nodes, which also capture the data. This allows the high volume of raw data to be compressed into summarized and interpreted results that are more suitable for transmission. Such embedded intelligence is achievable if the associated processing can be realized on the sensor embedded systems under the constraints imposed by their restricted available computational, memory, and energy resources.

Micro-electro-mechanical accelerometer sensors can capture information related to pose and movement. They are relatively inexpensive, consume little power, and take up little space. Accelerometry data is useful for building supervised machine-learning models to classify various behavioral activities of wildlife and livestock, particularly cattle

This disclosure provides classification models for cattle behavior that are suitable for implementation on embedded systems. To this end, a processor analyzes the tri-axial accelerometry data collected by sensor nodes fitted on collars and located on top of the neck of ten cattle. Based on visual observations of the cattle behavior, the data is labeled with six mutually-exclusive behavior classes, namely, grazing, walking, ruminating, resting, drinking, and other (a collective of all other behaviors). With the insights gained from the analysis, the processor extracts informative features from the appropriately-partitioned time segments of the accelerometer readings while keeping in mind the constraints of embedded systems. The raw labeled data is highly imbalanced. By sliding the partitioning time window with different stride lengths for different classes, we produce a balanced dataset that has roughly the same number of datapoints for each class. The resulting balanced dataset facilitates classification model learning and performance evaluation. Moreover, the less frequent but important behaviors, i.e., walking and drinking, constitute similar proportions of the dataset as the other more frequent behaviors. Thus, the datapoints of all classes participate equally to model learning and no class dominates or outweighs any other one. Without balancing, the less prevalent classes may be regarded as noise or outliers.

The processor extracts features from the windowed segment of the accelerometer readings that are pertinent to the pose (pitch) of the animal's head and the intensity of its body movements. The pose-related features are means of the accelerometer readings in three orthogonal spatial axes. To remove the effect of gravity, the processor applies two first-order high-pass Butterworth filters with different cut-off frequencies to the accelerometer reading. Subsequently, the processor calculates the intensity-related features as the mean of the absolute values of the filter outputs for all three spatial axes. The extracted intensity-related features are novel, and somewhat non-conventional, yet meaningful and interpretable. They lead to good classification performance and are computationally low-cost. The use of a second high-pass filter with a different cut-off frequency enables the extraction of further discriminative information, particularly from the spectral domain, with little additional resource consumption.

The extracted features are coupled with the related behavior annotations form a labeled dataset. In association with this dataset, we evaluate the performance of several classification algorithms whose learned models can be stored and used for prediction on embedded systems. The results are encouraging as they indicate that good in-situ cattle behavior classification, i.e., with accuracy close to 90%, is possible using linear classifiers such as logistic regression and support-vector machine.

### Experiment

During atrial from 31 July to 4 Sep. 2018 at the Commonwealth Scientific and Industrial Research Organisation (CSIRO) FD McMaster Laboratory Pasture Intake Facility, Armidale, NSW, Australia, we fitted ten cattle with collar tags specifically designed to collect, store, and process various types of data including inertial measurement, temperature, pressure, and geo-location (through the global navigation satellite system). The research undertaken in this work was approved by the CSIRO FD McMaster Laboratory Chiswick Animal Ethics Committee with the animal research authority number 17/20. The tag, houses a sensor node (mote), a battery pack, and photovoltaic modules for harvesting solar energy. We mount the tag on top of the animal's neck and secure it with a collar belt and a counterweight placed at the bottom of the neck.

The sensor node, named Loci, has a Texas Instruments CC2650F128 system-on-chip that consists of an Arm Cortex-M3 CPU running at 48 MHz with 28 KB of random access memory (RAM), 128 KB of read-only memory (ROM), and a 802.15.4 radio module. Loci also contains an MPU9250 9-axis micro-electro-mechanical (MEMS) inertial measurement unit (IMU) including a tri-axial accelerometer sensor that measures acceleration in three orthogonal spatial directions (axes). The x axis corresponds to the antero-posterior (forward/backward) direction, the y axis to the medio-lateral (horizontal/sideways) direction, and the z axis to the dorso-ventral (upward/downward) direction. The IMU chip outputs the accelerometer readings as 12-bit signed integers at a rate set to 50 samples per second. The operating system running on Loci is Contiki 3.

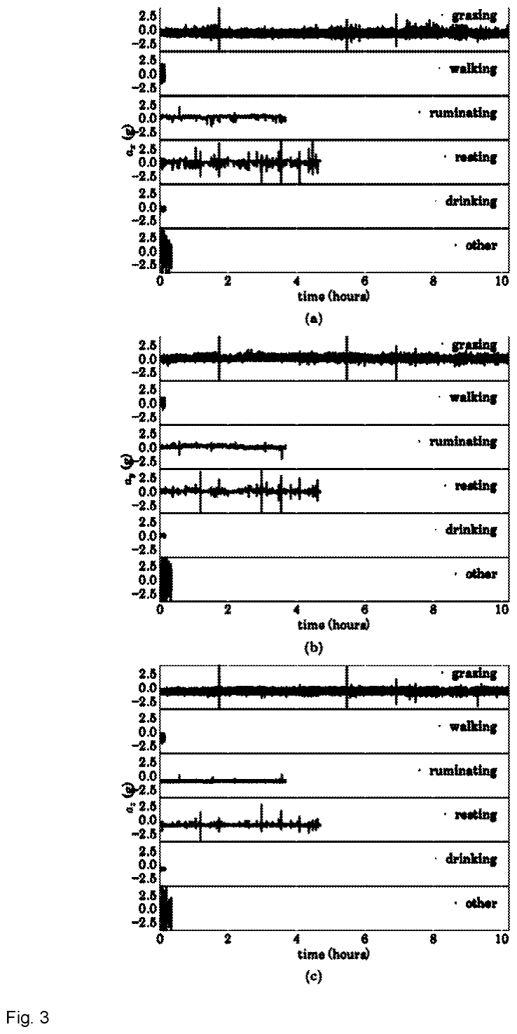

Throughout the experiment, the tags recorded the tri-axial accelerometer readings on external flash memory cards. We monitored the cattle wearing the tags and manually recorded their behaviors over a total period of approximately 19.2 hours. Using these observations, we annotated the corresponding accelerometry data after retrieving the tags and uploading the data at the end of the trial. The behaviors of interest were grazing, walking, ruminating (standing or lying), resting (standing or lying), drinking, and other. Table 1 shows the total annotated periods in seconds for each animal and each behavior. FIG. 3 shows the accelerometer readings concatenated over all annotated periods and all animals for each spatial axis, i.e., x, y, and z, denoted by aₓ, a_{y}, and a_{z}, respectively. Note that, in the figures, the accelerometer readings are shown in the units of earth's gravitational constant (g) only for the clarity of presentation. All the processing is done with the original 12-bit integer values.

TABLE 1
The total annotated periods in seconds for each animal and each behavior.

| behaviour | | | | | | | | | | | | |
|---|---|---|---|---|---|---|---|---|---|---|---|---|
| animal | 1 | 2 | 3 | 4 | 5 | 6 | 7 | 8 | 9 | 10 | all | % |
| grazing | 3824 | 2303 | 2023 | 2933 | 5759 | 3687 | 5244 | 3598 | 3493 | 3837 | 36701 | 53.074 |
| walking | 54 | 112 | 49 | 0 | 108 | 84 | 24 | 28 | 55 | 0 | 514 | 0.743 |
| ruminating | 1172 | 442 | 679 | 2226 | 1067 | 3279 | 305 | 2730 | 802 | 541 | 13243 | 19.151 |
| resting | 2742 | 1442 | 4294 | 506 | 805 | 2087 | 1061 | 1644 | 1970 | 346 | 16897 | 24.444 |
| drinking | 194 | 139 | 21 | 0 | 7 | 0 | 0 | 189 | 61 | 0 | 611 | 0.884 |
| other | 27 | 195 | 272 | 6 | 64 | 124 | 195 | 65 | 158 | 78 | 1184 | 1.712 |
| all | 8013 | 4633 | 7338 | 5671 | 7810 | 9261 | 6829 | 8254 | 6539 | 4802 | 69150 | 100 |

FIG. 3 illustrates the annotated accelerometer readings of all animals. As seen in Table 1 and FIG. 3, the raw annotated data is severely imbalanced with respect to the amount of observation for each behavior. Specifically, 53.074% of the data is labeled as grazing while the shares of the walking and drinking behavior classes are only 0.743% and 0.884%, respectively.

### Dataset

Monitoring devices 102 generate a labeled dataset for cattle behavior classification using the annotated accelerometry data. To this end, monitoring devices 102 divide the annotated accelerometer readings into overlapping sets consisting of the values for 10 consecutive seconds. Monitoring devices 102 then extract features from the values within each set to create the datapoints of the dataset. Monitoring devices 102 realize this by sliding a 10-second-wide time window over the annotated accelerometer readings. To balance the dataset, monitoring devices 102 use a different stride length (overlap ratio) for each behavior class. Monitoring devices 102 set the stride length for each class such that the number of 10-second windows are roughly the same for all classes. Table 2 shows the chosen stride length, i.e., the distance between the first samples of every two consecutive 10-second windows, and the resultant number and percentage of the overlapping 10-second windows for each class.

Note that using a different stride length for each class only serves to generate a balanced dataset and not to produce any new information. It can be viewed as being equivalent to making the maximum possible number of datapoints by sliding the partitioning window only one sample (accelerometer reading) for all classes, then subsample the datapoints in accordance with the stride lengths in Table 2. Although balancing the dataset does not add any new information, it has two main advantages. First, most supervised machine-learning algorithms learn more accurate and reliable classification models when the training dataset is balanced. Severe imbalance in a dataset can cause the minority classes to be dominated by the majority classes in model learning, sometimes leading to minority classes being treated as noise. Second, classification performance evaluation is generally more straightforward and comprehensible with balanced datasets. Especially, most classification accuracy measures are meaningful when the underlying dataset is balanced.

TABLE 2
The stride length of the sliding window for each class and the number
and percentage of the datapoints associated with each class.

| | |
|---|---|
| stride length | overlapping windows |

| behavior | samples | seconds | number | percentage |
|---|---|---|---|---|
| grazing | 706 | 14.12 | 2647 | 16.875 |
| walking | 2 | 0.04 | 2550 | 16.256 |
| ruminating | 248 | 4.96 | 2641 | 16.837 |
| resting | 277 | 5.54 | 2646 | 16.869 |
| drinking | 7 | 0.14 | 2656 | 16.932 |
| other | 14 | 0.28 | 2546 | 16.231 |
| all | — | — | 15686 | 100 |

### Feature Extraction

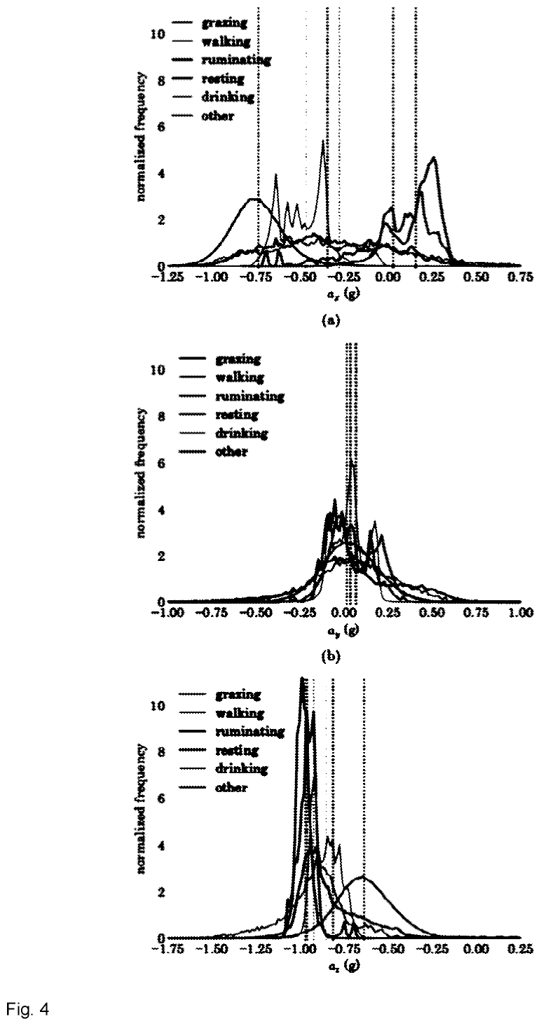

To gain some insight into the annotated accelerometry data and identify potential meaningful features to extract from the 10-second windows, we plot the normalized histogram for each class and each spatial axis averaged over all respective 10-second windows in FIG. 4. The dashed vertical lines in FIG. 4 are placed at the mean values and depicted in the same color as the corresponding classes.

A key observation from FIG. 4 is that the means, especially for x and z axes, are separated and as such potentially useful for discriminating the behavior classes. Specifically, the mean values corresponding to different behavior classes are relatively well apart on x axis. Considering where the sensor is mounted, the mean values can be interpreted as indicators of the orientation of the animal's neck/head. Since the constant acceleration due to earth's gravity is downward at the opposite direction of z axis, when the animal's neck/head is close to neutral position during the walking, ruminating, or resting behaviors, a_{z} is close to −1 g and aₓ is close to 0 g. On the other hand, when the animal lowers its head during the grazing and drinking behaviors, a_{z} becomes larger than −1 g and aₓ becomes smaller than 0 g. The means in y axis are close to zero for all behaviors indicating that the cattle do not tilt their heads sideways for any significant amount of time during any of the recorded behaviors. Thus, one can expect that the mean of a_{y} may not be of great help in discriminating the behaviors.

Our first three features are the means of the values of three axes for each 10-second window calculated as

$${f}_{x , i} = \frac{1}{{N}_{i}} {\sum }_{n ∈ {𝒯}_{i}} {a}_{x , n} \qquad ( 1 )$$

$${f}_{y , i} = \frac{1}{{N}_{i}} {\sum }_{n ∈ {𝒯}_{i}} {a}_{y , n}$$

$${f}_{z , i} = \frac{1}{{N}_{i}} {\sum }_{n ∈ {𝒯}_{i}} {a}_{z , n}$$

where f_{x,i} is the mean feature for the ith 10-second window and the x axis (similarly for y and z axes), the second index n of the accelerometer readings is for sample number (time), [symbol] is the set of indexes of the accelerometer readings within the ith window, and Nᵢ is the cardinality of [symbol] .

The histograms in FIG. 4, except those for the grazing behavior class, appear considerably irregular even after being averaged over all corresponding 10-second windows. We attribute this to two factors. First, the accelerometer readings are the superposition of the dynamic accelerations due to animal's body movement and the static acceleration due to earth's gravity. Since the tags are not secured tightly on the cattle, their orientations are not fixed at the ideally stipulated set-up of the x and y axes being parallel and the z axis perpendicular to the horizontal ground plane. Thus, the gravity component may be unpredictably variable for different tags or different times. Second, the accelerometer readings are noisy and the amount of data collected for most classes is not sufficient to average out the effects of noise.

Removing the contribution of earth's gravity to the accelerometer readings is not straightforward. This is mainly because the exact orientation of the sensors at any given time cannot be resolved as they are not firmly attached to the animals and can drift in all directions when the animal moves its body/head. This slack is inevitable and in fact necessary to make the collar tag practically wearable. The counterweight at the bottom of the collar helps keep the tag in place and re-position it when it shifts. The looseness of the tags implies that the projection of earth's gravity over the three spatial axes of the accelerometers is not purely static hence does not manifest only at the zero frequency but it may affect higher frequencies as well. This is further exacerbated by the non-ideal performance of the low-cost MEMS accelerometers used. However, one can assume that gravity mostly influences lower frequencies and has negligible impact at higher frequencies.

To remove the affect of gravity with minimal computational or memory overhead, monitoring devices 102 apply a first-order high-pass Butterworth filter to the accelerometer readings of each 10-second window. As this filter has an infinite impulse response with a single tunable parameter, its implementation requires at most a single multiplication and two additions per sample. The transfer function of this filter is expressed in the s domain as

$$H ( s ) = \frac{1}{1 + \frac{2 π {f}_{c}}{s}} \qquad ( 2 )$$

and in the z domain as

$$H ( 𝓏 ) = \frac{1 + γ}{2} \frac{1 - {𝓏}^{- 1}}{1 - {γ𝓏}^{- 1}} \qquad ( 3 )$$

where γ is the parameter of the filter that can be related to the cut-off frequency of the filter, denoted by f_{c}, and the sampling period, denoted by Tₛ, as

$$γ = \frac{1 - tan ( π {f}_{c} {T}_{s} )}{1 + tan ( π {f}_{c} {T}_{s} )} . \qquad ( 4 )$$

Thus, ignoring the constant gain factor

$$\frac{1 + γ}{2} ,$$

the application of the filter to the accelerometer readings in all axes can be written as

b_{x,n}=γb_{x,n-1}+a_{x,n}−a_{x,n-1}

b_{y,n}=γb_{y,n-1}+a_{y,n}−a_{y,n-1}

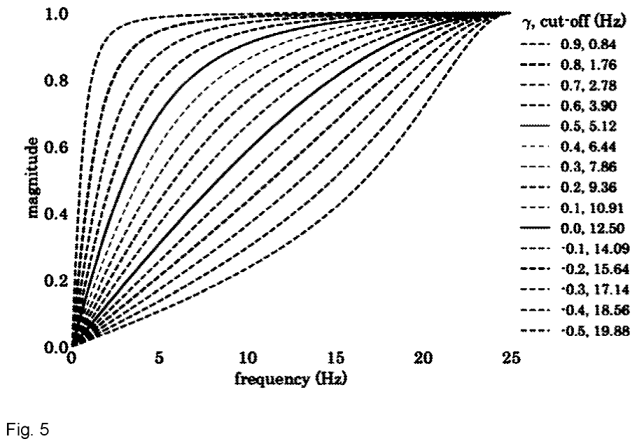

b_{z,n}=γb_{z,n-1}+a_{z,n}−a_{z,n-1} (5)

where b_{x,n}, b_{y,n}, and b_{z,n} are the filter outputs at sample number (time) n. FIG. 5 shows the frequency response of the filter when normalized to have unit gain at the Nyquist frequency using the gain

$$\frac{1 + γ}{2}$$

as in (3) for different values of γ and the corresponding cut-off frequencies. Note that the sampling frequency is 50 Hz. We will explain how we choose the value of γ later.

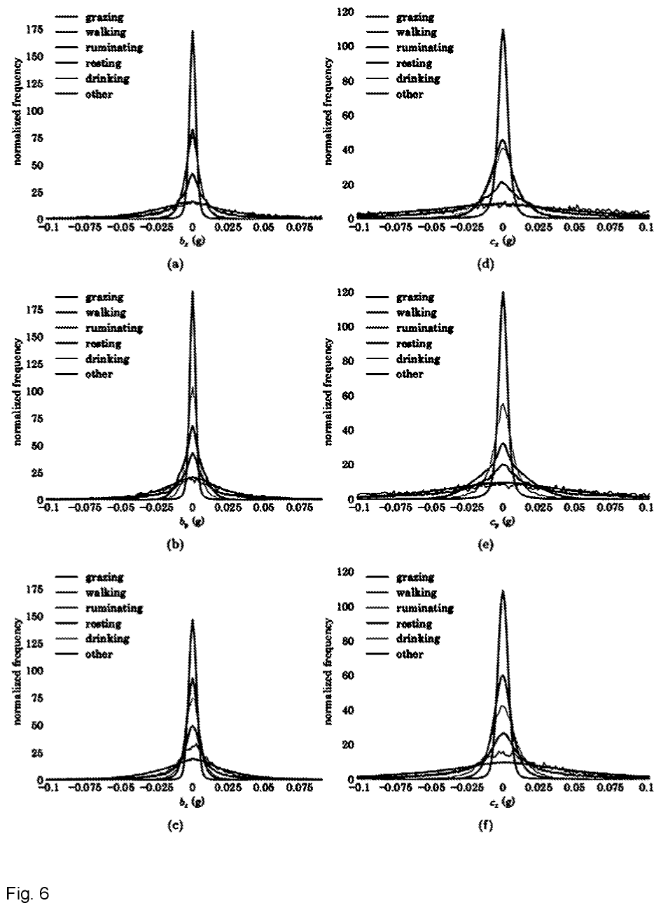

FIG. 6 shows the normalized histograms of the filtered accelerometer readings averaged over all 10-second windows for all classes and axes and two values of γ=0 and γ=0.5. As seen in the figure, the filter outputs are almost zero-mean and have significantly more regular and symmetric distributions compared with the non-filtered accelerometer readings (see FIG. 4). Moreover, the filter outputs of different classes have different statistical properties. Hence, the standard deviation or the second central moment of the filtered accelerometer readings may contain information that can be utilized to discriminate among the classes.

Therefore, to inspect the possibility of extracting useful features through second-order statistics, after the high-pass filtering and elimination of the effect of gravity, monitoring devices 102 calculate three more features from the filter outputs by averaging their absolute values. Since the mean of the filter output values for each axis is very close to zero, the mean absolute value is a good surrogate for the standard deviation. It is an equally effective measure of spread in the probability distribution while being more economic to calculate than the standard deviation. Monitoring devices 102 compute the mean-absolute features as

$$\begin{matrix}{g}_{x , i} = \frac{1}{{N}_{i}} {\sum }_{n ∈ {𝒯}_{i}} \vert {b}_{x , n} \vert \\ {g}_{y , i} = \frac{1}{{N}_{i}} {\sum }_{n ∈ {𝒯}_{i}} \vert {b}_{y , n} \vert \\ {g}_{𝓏 , i} = \frac{1}{{N}_{i}} {\sum }_{n ∈ {𝒯}_{i}} \vert {b}_{𝓏 , n} \vert\end{matrix} . \qquad ( 6 )$$

The features g_{x,i}, g_{y,i}, and g_{z,i} can be seen as representatives of the intensity of the animal's body movements while the contribution of the lower parts of the frequency spectrum has been suppressed to lessen the effect of gravity. The extent of this suppression depends on the shape of the frequency response of the filter and consequently the cut-off frequency that is determined by the parameter γ. However, since g_{x,i}, g_{y,i}, and g_{z,i} are single values aggregated over the whole spectrum, they may not possess sufficient discriminative power.

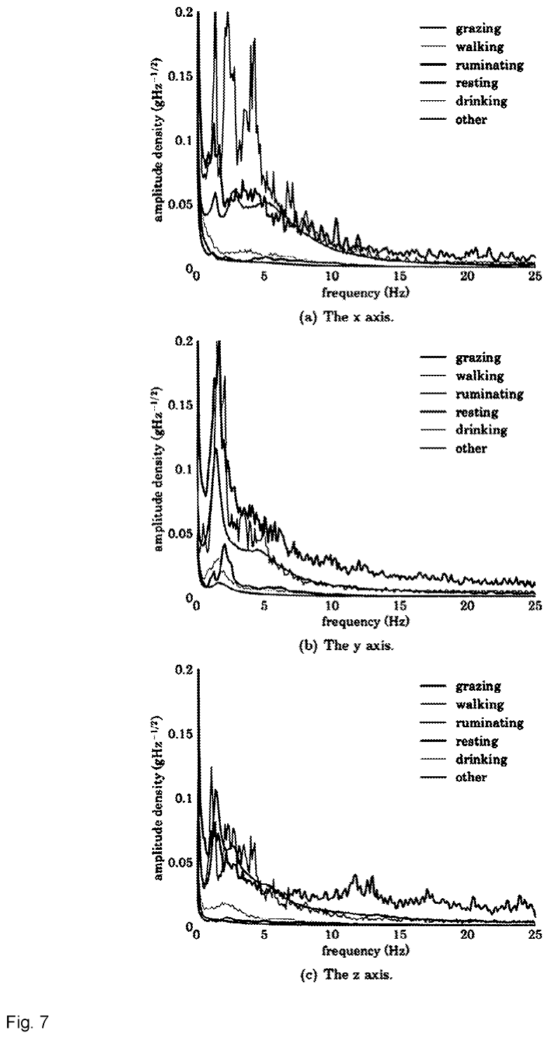

To provide more insight, we plot the amplitude spectral density (ASD) functions of the accelerometer readings averaged over all 10-second windows for all classes and axes in FIG. 7. The ASD function is the square-root of the power spectral density function. It portrays how the power of the accelerometer readings within the 10-second windows are on-average distributed over the spectral range of zero to 25 Hz (the Nyquist frequency that is half of the sampling frequency) for each class and axis. FIG. 7 shows that the overall power (intensity) of the activity captured by the accelerometers can be a good distinguishing factor among most classes. However, some behavior classes may have similar overall activity intensities, e.g., drinking and ruminating in y axis, but with different spectral characteristics. Such differences will be overlooked if only one high-pass filter is used and the filter outputs are combined into a single value such as the above-mentioned mean absolute.

To capture further discriminative information available within the spectral domain without incurring any substantial additional computational or memory complexity, we propose to utilize two first-order high-pass Butterworth filters with different parameters, γ₁ and γ₂, and obtain two sets of high-pass-filtered values as

b_{x,n}=γ₁b_{x,n-1}+a_{x,n}−a_{x,n-1}

b_{y,n}=γ₁b_{y,n-1}+a_{y,n}−a_{y,n-1}

b_{z,n}=γ₁b_{z,n-1}+a_{z,n}−a_{z,n-1}

c_{x,n}=γ₂c_{x,n-1}+a_{x,n}−a_{x,n-1}

c_{y,n}=γ₂c_{y,n-1}+a_{y,n}−a_{y,n-1}

c_{z,n}=γ₂c_{z,n-1}+a_{z,n}−a_{z,n-1}. (7)

Then, monitoring devices 102 compute six activity-intensity-related features, g_{x,i}, g_{y,i}, g_{z,i}, h_{x,i}, h_{y,i}, and h_{z,i}, for each 10-second window through (6) and

$$\begin{matrix}{h}_{x , i} = \frac{1}{{N}_{i}} {\sum }_{n ∈ {𝒯}_{i}} \vert {c}_{x , n} \vert \\ {h}_{y , i} = \frac{1}{{N}_{i}} {\sum }_{n ∈ {𝒯}_{i}} \vert {c}_{y , n} \vert \\ {h}_{𝓏 , i} = \frac{1}{{N}_{i}} {\sum }_{n ∈ {𝒯}_{i}} \vert {c}_{𝓏 , n} \vert\end{matrix} . \qquad ( 8 )$$

Meanwhile, we did not find any benefit in using three or more first-order high-pass Butterworth filters nor in using any higher-order high-pass filter. In addition, the higher, i.e., third or more, -order moments of the filtered accelerometer readings do not seem to contain any further discriminative information. Specifically, since the probability distributions of the filtered values are rather symmetric with thin tails, the odd-order moments are close to zero and the even-order moments, other than the second-order one, appear to be insignificant.

It is also worth noting that the window size of 10 second leads to a resolution of 0.1 Hz in the frequency spectrum that seems to be sufficient to highlight subtle differences between the classes, especially at low frequencies. In addition, as the accelerometer readings are considerably noisy, calculating features over 10 second windows, i.e. around 500 values, helps reduce the adverse effects of noise.

### Determining the Filter Parameters

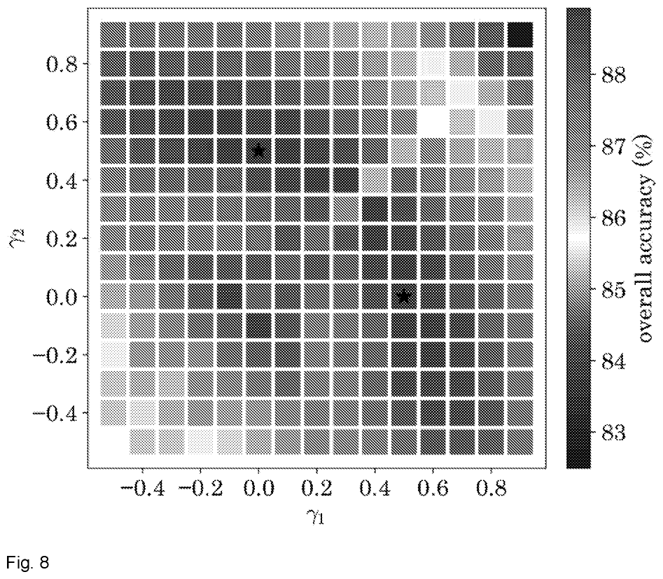

To decide the values of the filter parameters, γ₁ and γ₂, monitoring devices 102 evaluate the behavior classification performance for different combinations of γ₁ and γ₂ over a two-dimensional grid of values ranging from −0.5 to 0.9 with a step of 0.1. Monitoring devices 102 use the softmax (multinomial logistic regression) algorithm without any regularization to learn a behavior classification model for each combination. Monitoring devices 102 then evaluate the overall accuracy of the learned model for each point on the grid using a 5-fold stratified cross validation without any shuffling or randomization of the datapoints. The overall accuracy is the ratio of the number of correctly classified datapoints for all classes to the number of all datapoints. Here, it is a meaningful measure of general classification accuracy since our dataset is balanced. FIG. 8 shows the overall accuracy results on the considered grid. The maximum overall accuracy is achieved when γ₁=0, γ₂=0.5. Therefore, monitoring devices 102 use these values hereafter.

The points on the diagonal of the grid where γ₁=γ₂ correspond to when only one filter and consequently six features are used. It is clear from FIG. 8 that using two filters significantly improves the performance compared with using only one filter. As mentioned earlier, we did not witness any performance improvement when using three or more filters.

Our choice of the softmax algorithm with no regularization for determining the filter parameters is mainly due to its simplicity and lack of any tunable hyperparameter.

### Feature Selection

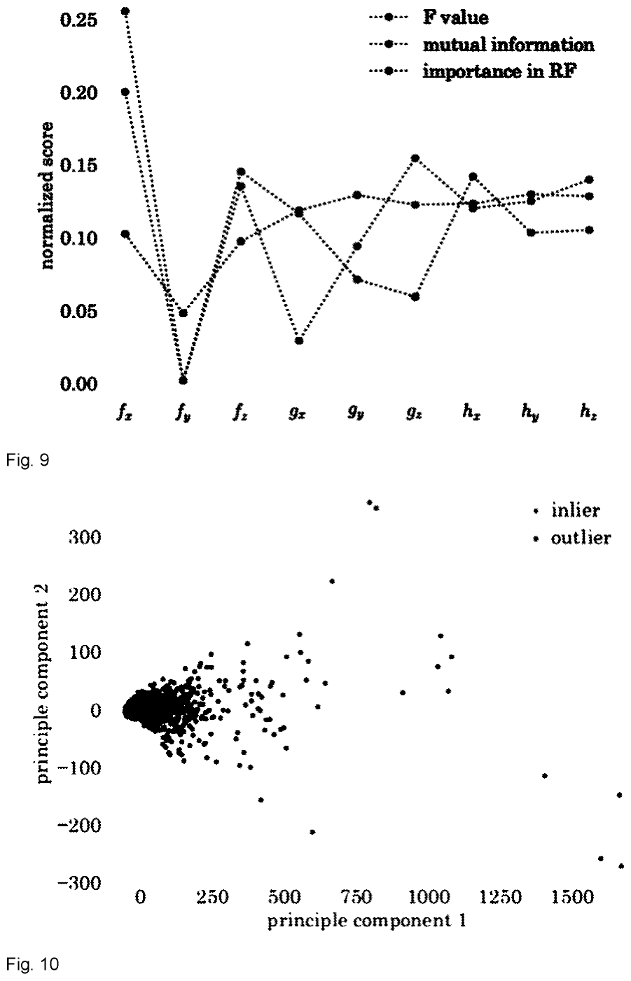

To make an initial comparative assessment of the usefulness of each extracted feature, we compute the analysis of variance (ANOVA) F-value and the estimated mutual information between the features and the corresponding class labels. We also examine the importance score of the features calculated by a random forest (RF) of 1000 classification trees each with maximum 10 leaf nodes. We plot the results in FIG. 9. It is evident that, as suspected earlier, the mean at y axis, f_{y}, is likely the least useful feature. Our experiments with various classification algorithms also confirms that f_{y} does not contribute to the model accuracy. All the other features are beneficial as excluding any of them degrades the performance. Henceforth, monitoring devices 102 use all features but f_{y} for building behavior classification models.

Dealing with the Outliers

While resting, be it standing or lying, cattle do not generally stay completely stationary but may occasionally move their head, flick ears, twitch various muscles in the body, etc. In our annotations, such occasions lasting less than a few seconds have still been labeled as resting. To minimize inaccuracies caused by such miscellaneous behaviors during the periods labeled as resting, monitoring devices 102 identify the outliers among the 10-second windows labeled as resting and relabel them as the other behavior.

Monitoring devices 102 employ the random cut forest (RCF) algorithm to detect the outliers. Monitoring devices 102 set the contamination ratio, i.e., the ratio of expected outliers in the resting 10-second windows, to 0.1 (10%) and the number of trees in the RCF to 1000. Monitoring devices 102 also use only the activity-intensity-related features gₓ, g_{y}, g_{z}, hₓ, h_{y}, and h_{z}. FIG. 10 visualizes the resting datapoints and the identified outliers by depicting their projection onto the plane spanned by their two principle components.

Note that the numbers and percentages given in Table 2 were calculated after eliminating the resting outliers by relabeling them as other.

### Visualization of the Dataset

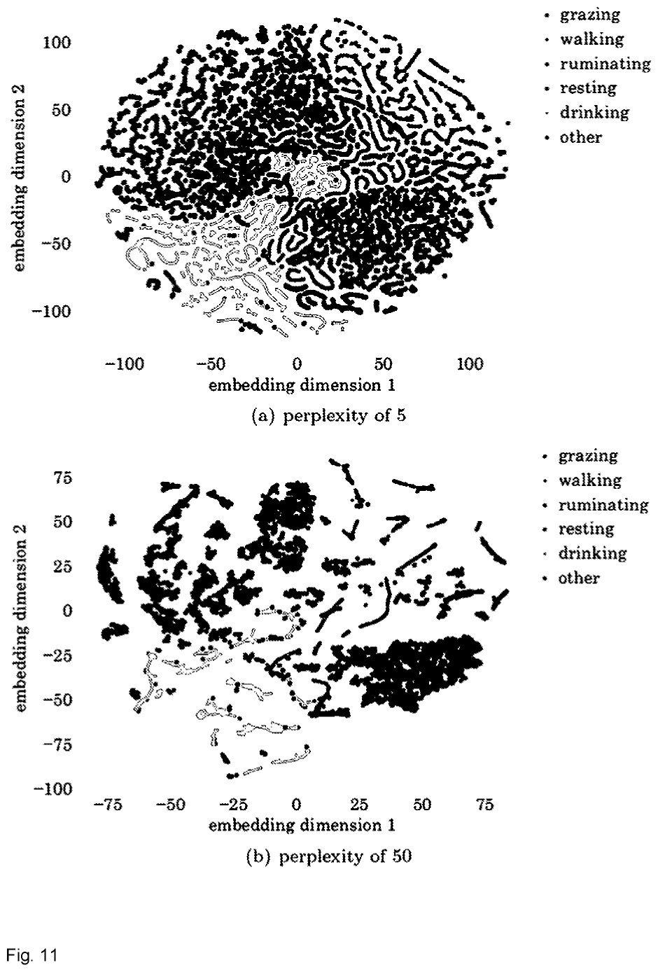

We visualize our dataset consisting of the features extracted from the 10-second windows and their pertaining class labels by projecting the eight-dimensional feature space of the dataset onto two dimensions using the t-distributed stochastic neighbor embedding (tSNE) algorithm. FIG. 11 depicts two visualizations of the dataset produced by tSNE when its perplexity parameter is set to two different values, i.e., 5 and 50. The perplexity parameter determines the number of nearest neighbors of each datapoint to whom the datapoint's distance is preserved in the low-dimensional embedding space. The tSNE algorithm preserves the local structural characteristics of the dataset, which it embeds into a lower-dimensional (in our case, two-dimensional) space. The dots representing the datapoints in FIG. 11 are colored according to their corresponding behavior class.

An important observation in FIG. 11 is that the datapoints of each class tend to cluster together and form rather well-defined boundaries segregating the classes, except for the other behavior class. This indicates that it is expectable to achieve good classification performance when using the extracted features. The performance may not be as good for the other behavior class since the datapoints corresponding to this class appear to be dispersed over a relatively large area within fragmented pockets in the feature space. This may be explained considering that this behavior class is a collection of possibly many different behaviors. The paucity of the data for the infrequent behaviors that constitute small fractions of the original annotated data (see Table 1 and FIG. 3), i.e., walking, drinking, and other, is also clearly manifested in FIG. 11(b) where the perplexity is 50.

### Behavior Classification

Extracting meaningful features as described in the previous section is the first step in developing a statistical model for predicting the behavior performed by a cattle based on accelerometer readings. The second step is learning a function that maps the extracted features to the corresponding behavior class labels. In this section, we examine the performance of various supervised machine-learning algorithms in learning such a mapping function and building an behavior classification model. Nevertheless, our goal is to perform behavior classification on embedded systems with constrained energy, memory, and computational resources. Therefore, we only consider the algorithms whose inference procedure can be implemented on typical embedded systems, particularly on our Loci sensor-node.

We consider the following algorithms: logistic regression (LR), softmax, support vector machine (SVM), decision tree (DT), linear discriminant analysis (LDA), quadratic discriminant analysis (QDA), and Gaussian naive Bayes (GNB). For the LR, SVM, and softmax algorithms, we use the l₂-norm regularization and tune the regularization parameter of each algorithm to attain the best possible overall accuracy. For SVM, we use the squared hinge loss. For DT, we set the maximum number of leaf nodes to 23. We use the scikit-learn Python package to train all classification models and evaluate their predictive performance.

For the LR and SVM algorithms, we use both one-versus-one (OvO) and one-versus-rest (OvR) reduction schemes. With the OvO scheme, a set of binary classifiers is used where each one is trained on the datapoints of a pair of classes and learns to distinguish those two classes. For inference, all 6(6−1)/2=15 binary classifiers are applied to a datapoint whose class is to be predicted (test datapoint) and the class with the highest cumulative score (or number of wins) is taken as the prediction of the combined classifier. In the OvR scheme, a set of binary classifiers each trained to distinguish the datapoints of one class from the rest of the dataset is used. At inference, all six binary classifiers are used to classify a test datapoint and the class whose respective classifier yields the highest score is taken as the prediction. The considered algorithms other than LR and SVM can inherently handle multiple classes.

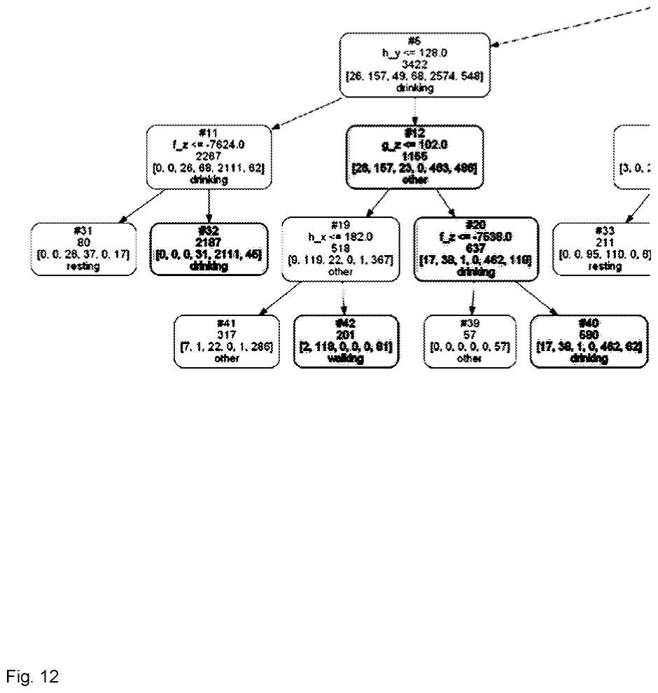

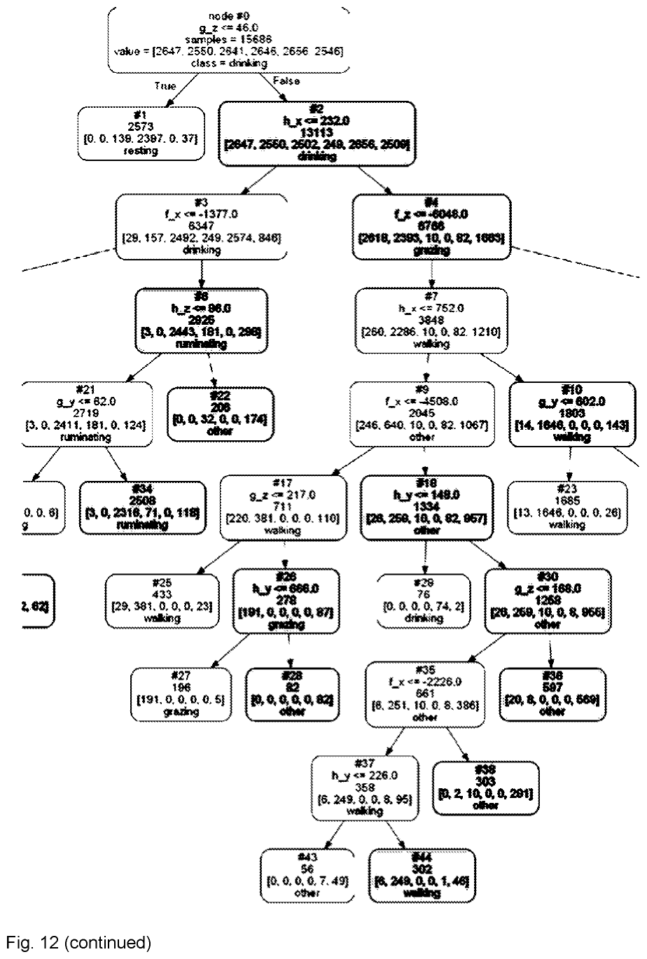

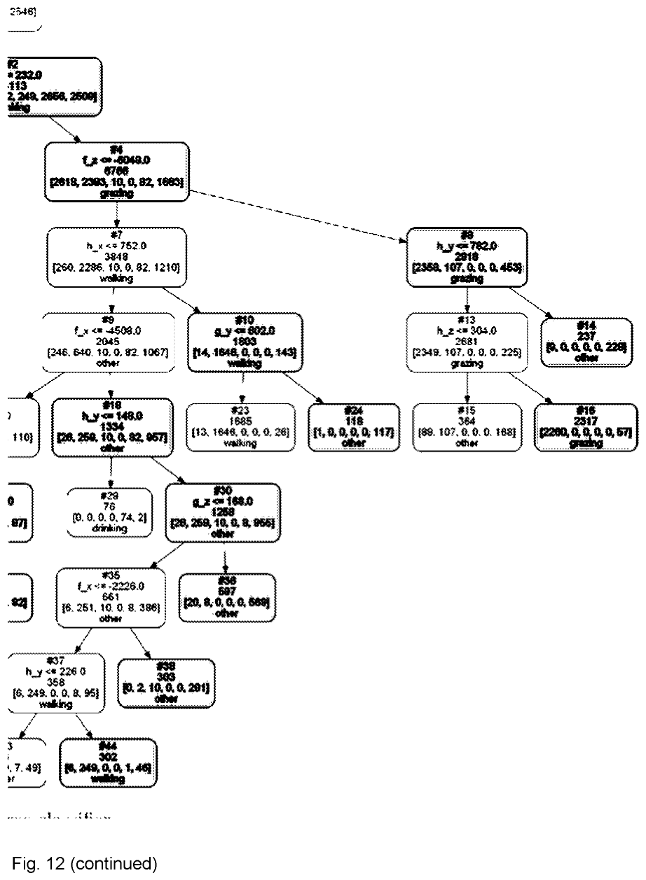

Table 3 shows the inference equation/procedure as well as the model parameters for each considered algorithm. Tables 4 and 5 also present the model size and computational complexity for performing classification inference using the considered algorithms in terms of the required number of integer and floating-point parameters and operations. In the calculations leading to the results of Table 4, we assume that the feature vectors, fₜ in Table 3, the mean vectors, m_{c∈C} in Table 3, and the thresholds of the learned DT have integer values. We also assume that each integer parameter takes up four bytes and each floating-point parameter eight bytes. Note that C denotes the set of indexes for all classes. The model size and required operations given for DT in Tables 4 and 5 are regarding the learned classification tree depicted in FIG. 12.

TABLE 3
The inference equation/procedure and model parameters for the considered classification
algorithms. The vector fₜ is the collection of features for the test datapoint
indexed by t, C is the set of all class labels, p(c) is the prior probability for class c,
m_{c} and Σ_{c} are the mean vector and covariance matrix for class c, respectively,
and Σ_{c}∀c∈C are diagonal in GNB.

| | |
|---|---|
| Algorithm: | LR-OvO, SVM-OvO |
| Inference: | [symbol] Σ_{c′∈} [symbol] \cw_{c,c}^{T},fₜ + b_{c,c′} |
| | w_{c′,c} = −w_{c,c′},b_{c′,c} = b_{c,c′} ∀c,c′ ∈ [symbol] & c ≠ c′ |
| Model parameters: | w_{c,c′},b_{c,c′} |
| Algorithm: | LR-OvR, SVM-OvR, softmax, LDA |
| Inference: | [symbol] w_{c}^{T}fₜ + b_{c} |
| Model parameters: | w_{c},b_{c} |
| Algorithm: | DT |
| Inference: | run through the tree comparing the feature |

values with the thresholds until reaching a leaf node

| | |
|---|---|
| Model parameters: | tree structure, see Fig. 12 |
| Algorithm: | QDA, GNB |
| Inference: | [symbol] 2ln[ p(c)\| Σ_{c} \|^{-1/2} ] − (fₜ − m_{c})^{T} Σ_{c}⁻¹(fₜ − m_{c}) |
| Model parameters: | m_{c}, Σ_{c}⁻¹, 2ln[ p(c)\| Σ_{c} \|^{-1/2} ] |

TABLE 4
The classification model size of the considered algorithms in terms
of the number of required integer and floating-point parameters
as well as the total byte count assuming four bytes for each integer
parameter and eight byte for each floating-point parameter.

| | parameters | | total |
|---|---|---|---|
| algorithm | integer | floating-point | bytes |
| LR-OvO, SVM-OvO | 0 | 135 | 1080 |
| [1]LR-OvR, SVM-OvR, softmax, LDA | 0 | 54 | 432 |
| DT | 78 | 0 | 312 |
| QDA | 48 | 222 | 1968 |
| GNB | 48 | 54 | 624 |

TABLE 5
The number of required integer and floating-point operations
to perform inference using the considered algorithms.

| | integer | | floating-point | |
|---|---|---|---|---|
| algorithm | + | × | + | × |
| LR-OvO, SVM-OvO | 0 | 0 | 149 | 120 |
| [I]LR-OvR, SVM-OvR, softmax, LDA | 0 | 0 | 53 | 48 |
| DT | 2-8 | 0 | 0 | 0 |
| QDA | 48 | 0 | 389 | 432 |
| GNB | 48 | 48 | 53 | 48 |

It is evident from Tables 4 and 5 that the number of computations that the considered algorithms require for inference as well as the amount of memory they require for model storage is well within the affordability of most embedded systems. On the other hand, more complex classification algorithms such as SVM with a radial basis function (RBF) kernel, k nearest neighbor, multi-layer perception, and random forest generally demand significantly higher resources for both performing inference and storing the pertinent model.

Table 6 presents the results of cross-validated performance evaluation of the considered algorithms with our cattle behavior dataset in terms of the F1 score for all classes. The F1 score is the harmonic mean of the precision and recall. It is a positive scalar and has the best value of one with perfect precision. Table 7 shows the cross-validated overall accuracy, cross-entropy score, and Brier score for all algorithms. The cross-entropy and Brier scores are measures of the accuracy of probabilistic forecast when probabilities are assigned to the class predictions. The cross-entropy score is the negative log-likelihood of the true class averaged over all datapoints given the probabilities predicted for every class. The Brier score is the mean of squared difference between the predicted probabilities and the actual class of every datapoint. Therefore, smaller cross-entropy and Brier scores indicate better calibrated probabilistic predictions.

TABLE 6
The results of performance evaluation via 5-fold stratified
cross-validation in terms of F1 score for the considered
algorithms. The three highest values in each column are
colored green, blue, and red, respectively.

| | grazing | walking | ruminating | resting | drinking | other |
|---|---|---|---|---|---|---|
| LR-OvO | 0.945 | 0.889 | 0.920 | 0.936 | 0.940 | 0.760 |
| SVM-OvO | 0.948 | 0.879 | 0.919 | 0.937 | 0.945 | 0.758 |
| LR-OvR | 0.961 | 0.922 | 0.892 | 0.914 | 0.877 | 0.749 |
| SVM-OvR | 0.962 | 0.928 | 0.891 | 0.905 | 0.871 | 0.737 |
| softmax | 0.960 | 0.859 | 0.918 | 0.937 | 0.927 | 0.740 |
| DT | 0.908 | 0.791 | 0.869 | 0.912 | 0.877 | 0.624 |
| QDA | 0.900 | 0.778 | 0.885 | 0.918 | 0.865 | 0.607 |
| GNB | 0.868 | 0.679 | 0.887 | 0.916 | 0.849 | 0.403 |
| LDA | 0.947 | 0.792 | 0.721 | 0.649 | 0.776 | 0.422 |

TABLE 7
The overall accuracy, cross-entropy score, and
Brier score of the considered algorithms.

| | overall | cross-entropy | |
|---|---|---|---|
| algorithm | accuracy (%) | score | Brier score |
| LR-OvO | 89.90 | 1.102 | 0.580 |
| SVM-OvO | 89.78 | 1.097 | 0.577 |
| LR-OvR | 88.80 | 0.417 | 0.200 |
| SVM-OvR | 88.53 | 1.624 | 0.775 |
| softmax | 89.14 | 0.469 | 0.180 |
| DT | 83.14 | 1.365 | 0.283 |
| QDA | 82.63 | 1.103 | 0.293 |
| GNB | 78.90 | 1.659 | 0.364 |
| LDA | 73.28 | 0.944 | 0.388 |

We use a 5-fold stratified cross-validation without shuffling the datapoints. Stratification helps protect the balance in the prevalence of the datapoints of different classes within all five cross-validation folds. We avoid shuffling the datapoints when dividing them into the folds to respect the time-series nature of the accelerometer readings and acknowledge the fact that datapoints generated from consecutive 10-second windows may be correlated and shuffling can lead to information leakage from the training set into the test set.

As seen in Tables 6 and 7, the LR, SVM, and softmax algorithms perform noticeably better than the other considered algorithms. The softmax algorithm is particularly interesting as its overall accuracy is very close to those of the best-performing algorithms, LR and SVM, while requiring appreciably less computations and model memory for inference. In addition, it has low cross-entropy and Brier scores. All algorithms except LDA exhibit good performance in recognizing the grazing, ruminating, resting, and drinking behavior classes. However, all algorithms are less accurate in distinguishing the other behavior class. The results for the walking class are somewhat mixed.

According to Table 7, the LR and SVM algorithms using the OvO reduction scheme slightly outperform their OvR-based counterparts in terms of the overall accuracy. This might be due to the fact that although the whole dataset is balanced in the multiclass sense, it is not balanced from the perspective of the binary classifiers of the OvR scheme.

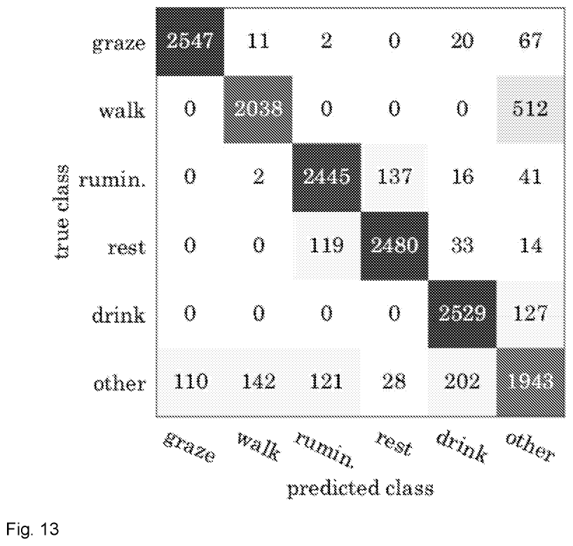

FIG. 13 shows the confusion matrix produced by the predictions of the softmax algorithm. It contains the number of datapoints of each class that have been classified as belonging to any of the six classes. It is evident that the walking and other behavior classes are the most mutually confused pair of classes. This can be attributed to the fact that both of these behaviors are high-intensity and have similar spectral characteristics. Moreover, short periods of movement not recognized as walking are annotated as other. The relative scarcity of these behaviors might also be a factor as the available data may not contain sufficient information for building a model that can distinguish these behaviors well. Furthermore, the other behavior class involves a variety of behaviors such as grooming, scratching, defecating, urinating, etc. making it generally hard to differentiate from the rest of the considered behaviors. It is also clear from the confusion matrix in FIG. 13 that the misclassifications in the resting and ruminating instances are mostly due to mutual confusion between these two classes. This may be explained by considering that both behaviors are low-intensity and, more importantly, it is often hard to clearly separate the periods when a cattle rests or ruminates. In fact, there may be short resting episodes during ruminating and vice versa that may not be exactly captured in our manual annotations.

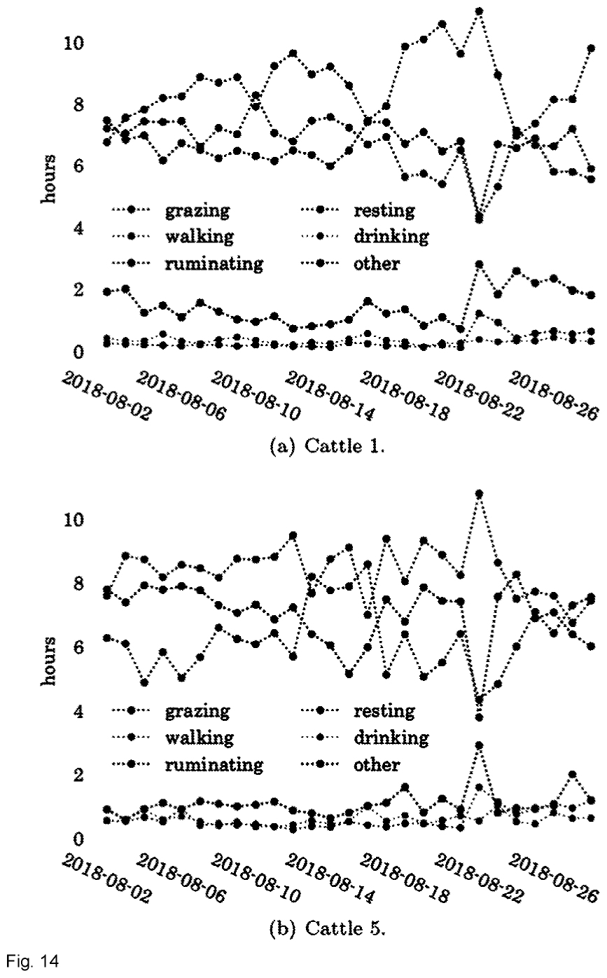

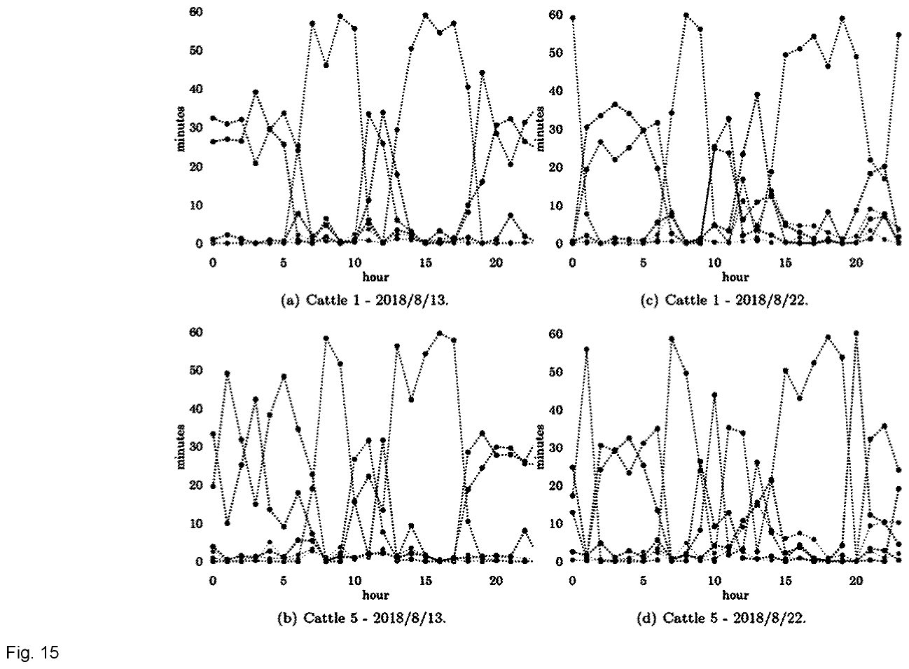

To provide a qualitative assessment of broader generalizability of the knowledge gained from our annotated accelerometry data to unseen instances, monitoring devices 102 use the softmax classification model trained on our cattle behavior dataset to predict the behaviors of two cattle for the entire period of the experiment totaling 591,490 datapoints, albeit without the exact ground-truth information for the whole period. FIG. 14 presents the results for the two considered cattle when the predictions are aggregated over every calendar day. FIG. 15 shows the results for both cattle and the periods of two different calendar days with the behavior predictions aggregated over every calendar hour.

The durations and temporal trends of various behaviors in FIGS. 14 and 15 are generally as expected. For example, the daily grazing, ruminating, and resting times in FIG. 14 are in agreement with the previous observations for grazing cattle. In addition, the morning and afternoon grazing sessions are clearly highlighted in FIG. 15. It is also seen that the cattle spend most of their time between the grazing episodes to rest and ruminate. As the trial took place within relatively small paddocks, there was no need for cattle to walk for long time periods. Therefore, they spend little time walking. This is clearly reflected in FIGS. 14 and 15.

### In-Situ Classification

With a time window of 10 second and a sampling rate of 50 samples per second, the features for every datapoint are calculated using 500 accelerometer readings in each axis. To avoid the expensive division operations required to average the accelerometer readings in (1) and the absolute values of the filter outputs in (6) and (8) for calculating the features, monitoring devices 102 use 512 values instead and replace the divisions by bit shifts. Since monitoring devices 102 set the filter parameters to γ₁=0 and γ₂=0.5 and the multiplication by 0.5 can be implemented as a bit shift, the calculation of the features can be realized using only integer additions and bit shifts with no need for any multiplication/division or any floating-point operation. The calculated feature values are hence integers. In addition, to prevent a possible overflow when summing up the accelerometer readings or the absolute values of the filter outputs, monitoring devices 102 average every 64 consecutive values then average the last eight 64-average values to obtain the features. Thus, monitoring devices 102 only store the last 64 values and the last eight 64-average values. Accordingly, monitoring devices 102 are able to calculate the features and carry out inference as every new 64 accelerometer readings become available, i.e., every 1.28 seconds. As such, the inference time window is sliding with a width of 10.24 seconds and a stride of 1.28 seconds.

We implement the inference procedure for behavior class prediction using the learned classification models on Loci with the aid of the skleam-porter package. This package contains C code for implementing several trained classification models produced by scikit-learn on embedded systems.

In Table 8, we show the average number of CPU cycles and the average processing time required for performing inference via each considered algorithm on Loci. The values given in Table 8 are averaged over 200 independent trails as the complexity of floating-point operations is non-deterministic.

TABLE 8
The average number of CPU cycles and the average
time taken by the considered algorithms to perform
inference for behavior classification on Loci.

| algorithm | CPU cycles | time (μs) |
|---|---|---|
| LR-OvO, SVM-OvO | 18,354.8 ± 31 | 382.4 ± 0.65 |
| LR-OvR, SVM-OvR, softmax, LDA | 6,820.9 ± 19 | 142.1 ± 0.4 |
| DT | 112 ± 0 | 2.3 ± 0 |
| QDA | 55,866.3 ± 54.9 | 1,163.9 ± 1.1 |
| GNB | 8,012.1 ± 19.2 | 166.9 ± 0.4 |

Besides the memory needed to store the model parameters (as in Tables 4) and the inference routine, the working memory required for calculating the features is only about (64+8)×9×4=2592 bytes assuming each integer number takes up 4 bytes. Overall, in-situ behavior classification using any of the examined algorithms can be conveniently performed on Loci without imposing any strain on the available computational or memory resources.

An interesting finding is that the relatively simple linear discriminative models, LR, SVM, and softmax (also DT and QDA to some extent) can distinguish the rare behaviors, walking and drinking, rather well despite the small amount of annotated data for these classes. This is particularly important as these behaviors are often much less frequent compared to the common behaviors of grazing (feeding), ruminating, and resting. In fact, almost all cattle behavior datasets are bound to be unbalanced regardless of the quantity of annotations since, in any realistic trial, one cannot essentially expect to observe biologically significant but infrequent behaviors, such as drinking, in abundance.

Our feature extraction approach is somewhat heuristic albeit being founded on theoretical insights, domain expertise, existing body of knowledge in the literature, and our extensive examinations and observations. Another approach for feature extraction that can make most of the available discriminative information is to use an appropriate filter bank whose parameters are estimated alongside training the classification model in a so-called end-to-end learning manner. However, apart from the challenges associated with such concurrent representation and classification model learning, the learned end-to-end model should be fit for performing inference on embedded systems. This is a topic of our ongoing investigations.

We chose to use the softmax algorithm for predicting the class labels in FIGS. 14 and 15 not only for its good accuracy and smaller computational and memory footprint compared with the LR and SVM algorithms but also for its reliable probabilistic predictions. As the softmax algorithm is the multiclass extension of the LR algorithm and hence directly optimizes a multiclass cross-entropy cost function, its predicted class scores (the softmax function outputs) can be interpreted as confidence levels. This means the probabilities output by the decision function of the algorithm are in good alignment with the real likelihoods. In other words, the softmax algorithm's predicted class probabilities are inherently calibrated. On the other hand, maximum-margin algorithms like SVM are known to yield uncalibrated probability estimates with a tendency to be under-confident with the classification decisions made. Moreover, generative-model-based classifiers that are built on imperfect assumptions or approximations such as LDA, QDA, and GNB usually return biased probability estimates.

### A Trust Architecture for Blockchain in IoT

Farm 100 relies on Internet of Things (IoT) sensors to capture observations of the physical domain and record them digitally, effectively converting continuous physical signals into digital signals in the process. In other words, IoT provides observations of the true state of the physical domain. These observations may be subject to noise, bias, sensor drift, or malicious alterations. Trust in IoT systems is critical at three distinct levels: (1) the data layer that relates to sensor and other observational data; (2) the interaction layer that relates to communications among devices in the IoT network; and (3) the application layer that relates to data processing and the interactions between service providers and service users.

This disclosure provides trust mechanisms that cut across these levels to ensure the end-to-end integrity of the collected data and the associated interactions. One key to fulfilling these requirements is the transparency of data collection processes and the associated interactions, in addition to the ability to audit these processes and interactions. Both the transparency and auditability requirements motivate the consideration of blockchain to underpin trust in IoT. Some examples are presented herein in the context of rooms in a building, noting that this is for illustrative purposes only and the rooms can be substituted for paddocks, areas, or farms in other examples.

Blockchain is a distributed ledger and has been applied to non-monetary applications. Blockchain is immutable as it is jointly managed by network participants through a consensus mechanism, such as Proof-of-Work (PoW), Proof-of-Stake (PoS), or Proof-of-Elapsed-Time (PoET). Consensus delivers agreement among the network participants, which are untrusted, on the current state of the ledger. In effect, trust in the current state is decentralised due to its coupling to the outcome of distributed consensus among the participants.

In the context of IoT, blockchain provides an immutable audit trail of sensor observations by linking the hash of the sensor data to blockchain transactions. The transactions themselves record immutable records of interactions among IoT devices and other network entities. Transactions are grouped into blocks that are linked through cryptographic hash functions to previous blocks in the chain, making it virtually impossible to alter previously stored blocks without detection. Using public key cryptography, blockchain can verify the authenticity of IoT transactions and blocks, before they are added to the blockchain. Once the blocks are mined into the blockchain, we have a guarantee that the inter-node interactions recorded in the block's transactions are securely recorded and are tamper-proof Providing a tamper-proof audit trail of inter-node interactions is a necessary but insufficient element to deliver end-to-end trust in IoT. Storing the hash of the data on the blockchain does ensure that the integrity of the stored data can be verified by comparing its hash against the blockchain-stored hash value. The authenticity of the observational data itself in the first place, however, is not guaranteed. As IoT data is an observation of the physical environment, its capture can involve noise, bias, sensor drift, or manipulation by a malicious entity. The immutability of blockchain does not protect against this risk associated with data capture, as inaccurate observational data that is secured with blockchain may not be useful to the IoT end users.

The discussion above highlights the intertwined nature of trust in IoT involving both the inter-node interactions and the data capture process. There is a clear need for an integrated architecture to deliver end-to-end trust that cuts across the data collection and blockchain node interactions in IoT. To address this problem, this disclosure provides a layered trust architecture for blockchain-based IoT applications. This architecture provides end-to-end trust from data observation to blockchain validation. To enhance trust in observational data, node computers (such as gateway device 104 or server 111) use the observer's long-term reputation, its own confidence in its data, and corroborating data from neighboring observers. Trust at the block generation level is established based on verifying transactions through our adaptive block validation mechanism.

Contributions are:
A layered trust architecture for IoT blockchain networks that delivers end-to-end trust from data observation to blockchain validation
Evaluation of the proposed IoT data observation trust mechanism through a simulated target localization scenario
A customized blockchain architecture for IoT built on lightweight block generation, adaptive block validation, and distributed consensus mechanisms
Implementation of the end-to-end trust architecture using a customized blockchain for IoT applications
Qualitative security analysis of the proposed architecture against possible attack scenarios

This disclosure provides a trust architecture that takes into account both the data and the blockchain layers to improve the end-to-end trust.

### Trust Architecture

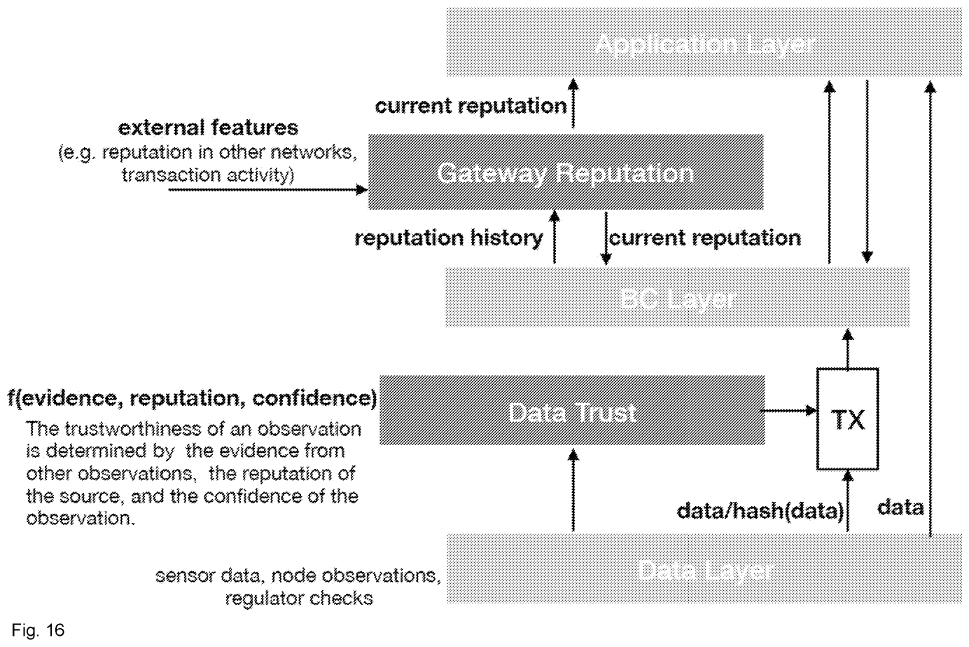

We propose a blockchain-based layered trust architecture for IoT as shown in FIG. 16. The architecture includes three key layers, namely the data layer, the blockchain layer, and the application layer. The data layer involves the collection of observational data from IoT devices and other sources, such as manually entered data by regulators or social media streams, that represent observations of physical events. For simplicity, we use sensor nodes and IoT devices interchangeably to refer to the data sources in the rest of the disclosure. Observational data is hashed and can be stored off-the-chain, such as on public chain 114, while transactions recording its collection and communication are stored on the blockchain 113. The blockchain layer receives transactions from the data layer, and maintains the blockchain while having bi-directional interactions with the application layer. The application layer is responsible for data processing and providing services to the end-users. Depending on the application-specific requirements or the specifications received from the end-users, the application layer communicates with the blockchain layer to adapt the block validation mechanism.

Our architecture introduces two key modules for trust management: (1) the data trust module; and (2) the gateway reputation module. The data trust module quantifies the confidence in specific observational data based on: the evidence from other nearby data sources; the reputation of the data source based on the long-term behaviour; and the confidence level of the observation reported by the data source. It uses inputs from the data layer and records the trust value of observations into their associated transactions. The reputation module tracks a blockchain network participant's long-term reliability. It inputs information from the blockchain layer on a participant's reputation history, and continuously updates the reputation to provide it to both the blockchain and application layers. The blockchain layer can use the updated reputation to dynamically adapt its transaction or block validation requirements of other participants, where blocks from more trustworthy receive less scrutiny. The application layer can use updated reputation scores to offer economic incentives to highly reputable nodes, such as through increased business interactions. The reputation module can also incorporate external inputs, such as a participant's reputation from external systems, referred to as reputation transfer. Next, we introduce the underlying network model for the proposed architecture before proceeding to the details of the proposed trust and reputation mechanisms.

### Network Model

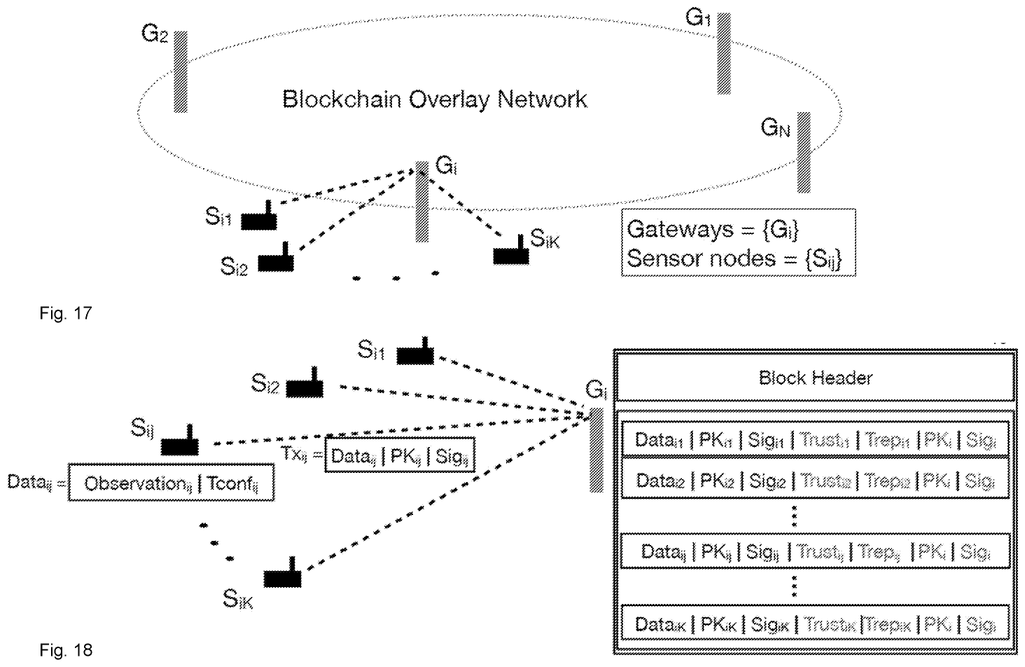

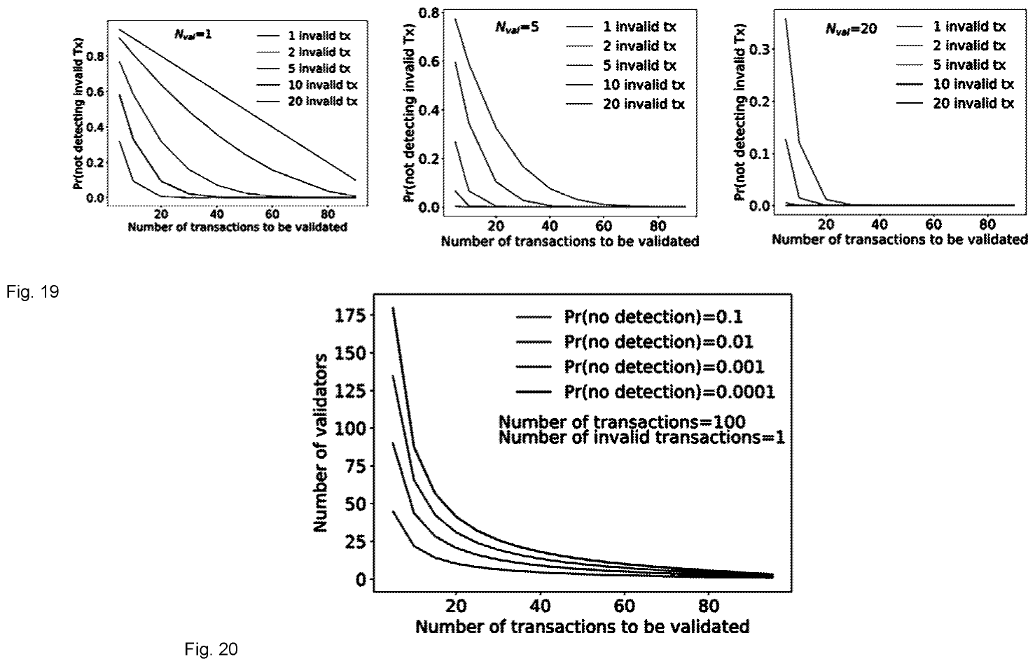

Due to the resource constraints and the limited capabilities of IoT nodes, we consider a two-tiered IoT network model as shown in FIG. 17, which is application agnostic, and can be used for a diverse range of IoT applications. The tiered model is a generic architecture for constrained IoT networks [15]. The upper tier consists of a set of gateway nodes G={G₁, G₂, . . . ,G_{N}} that constitutes the blockchain overlay network. Without loss of generality, we assume that each gateway node G is associated with a set of K sensor nodes Sᵢ={Sᵢ₁, Sᵢ₂, . . . , S_{iK}} and responsible for collecting data from the sensor nodes and maintaining a blockchain network by participating in the block generation and block validation processes. The lower tier consists of the sensor nodes, which collect data from the environment and transmit the collected data to the associated gateways through transactions. The sensor nodes associated with the same gateway and in close proximity to each other are assumed to have correlated observations (eg. acoustic sensors in a room). For larger networks where a large number of nodes are associated with a gateway, nodes can be clustered so that observations within the same cluster are highly correlated [16]. Every node in the network holds a unique public and private key pair. During the network initialization phase, nodes register to the network using their public keys and digital profiles are created for the nodes on the blockchain to record their public keys, their network associations (i.e. the public keys of the associated nodes), and their reputation scores. Nodes use their private keys to sign their transactions. These signatures can be verified by the gateway nodes, which have access to the public keys of the nodes recorded in their digital profiles.

### Trust and Reputation Mechanisms

Having defined the key components of our trust architecture, we now focus on generic mechanisms for managing trust and reputation within this framework.

### Trust Management

Recall that trust in our architecture refers to the instantaneous confidence in observations.

Assuming that neighboring sensor nodes connected to the same gateway have correlated observations due to close proximity, the observations of neighbouring sensor nodes can be used as evidence for the trustworthiness of a sensor observation. Sensor nodes build a history of reputation based on the evidence of other sensor node observations. A sensor node whose observations are supported by evidence most of the time has a higher reputation than a sensor node whose observations are not supported.

The reputation component in our data trust mechanism represents a node's long-term behaviour and affects the trust value of the observation data it provides. While the long-term reputation of a sensor node evolves with time, the trust value of the data is instantaneous for each observation. The other element that feeds into trusting a particular observation from a sensor node, which has yet to be considered, is the node's own confidence or uncertainty in its observations. For instance, a location estimate obtained from GPS is often associated with a position uncertainty estimate, which is the GPS module's estimate of error based on the received satellite signal and algorithm features. Including this uncertainty into the trust computation for the location observation provides the observer's own account of possible inaccuracies in its measurement. As a result, node computers model the trust in an observation Observationᵢⱼ at the data layer as:

Trustᵢⱼ=f(Tsensᵢⱼ,Trepᵢⱼ,Tconfᵢⱼ) (9)

where f is a function mapping the evidence from other sensor node observations Tsensᵢⱼ, the reputation of the sensor node Trepᵢⱼ, as well as the node's uncertainty in its observation Tconfᵢⱼ, to the trust level Trustᵢⱼ in this observation. All the terms refer to values at the current time t, so we omit this notation for simplicity. Evidence supporting the observation, higher reputation of the data source, as well as lower observation uncertainty should all lead to a higher trust value in the observation. The definition of the mapping f and the trust components (i.e., evidence, reputation, and confidence) are application-specific and dependent on the relevant sensing modalities. To illustrate how the gateway nodes can assign the trust values to sensor observations, let us consider the simple mapping:

Trustᵢⱼ=Tsensᵢⱼ×Trepᵢⱼ×Tconfᵢⱼ (10)

and FIG. 18, where the gateway G receives transactions from the associated sensor nodes and creates a new block with the received transactions. In this block, every transaction is signed by the sensor node generating the transaction, and the gateway node for authentication.

Confidence of the data source (Tconfᵢⱼ): Confidence of the data source represents how confident the data source is in its observation and can be modelled as a variable Tconfᵢⱼ ∈[0,1], whose value is determined by the data source and transmitted to the gateway together with the observation. Thus, the transaction from the data source Sᵢⱼ to the gateway G, becomes:

Txᵢⱼ=[Observationᵢⱼ|Tconfᵢⱼ|PKᵢⱼ|Sigᵢⱼ] (11)

where PKᵢⱼ and Sigᵢⱼ are the public key and the signature of the node Sᵢⱼ, respectively. The confidence of the data source depends on the application-specific confidence model. As an example, the confidence of a GPS sensor node would be high when the received GPS signal is strong, and low when the received signal is weak. Furthermore, a fixed confidence value can be assigned to nodes who do not receive any GPS fix. We present a confidence model for sensor nodes that use the Received Signal Strength Indicator (RSSI) for determining the proximity of a beacon node for the indoor target localization application. In this sense, the mere fact that data has been received from a sensor wirelessly at a gateway, means that the sensor must have been at close proximity to the gateway. Therefore, relatively high trust can be placed in the locality of that sensor data. This provides an additional source of trust to the disclosed system.

Evidence from other observations (Tsensᵢⱼ): The gateway uses the correlation in sensor observations to calculate the evidence component for the trust in observations. The gateway G, calculates the evidence Tsensᵢⱼ for the observation Observationᵢⱼ based on the data received from the neighboring sensor nodes of Sᵢⱼ. The neighborhood information is recorded in the profiles of the nodes on blockchain. If a sensor observation Observationᵢₘ supports Observationᵢⱼ, it increases Tsensᵢⱼ by a value proportional to its own observation confidence Tconfᵢₘ. Otherwise, if Observationᵢₘ does not support Observationᵢⱼ, it decreases Tsensᵢⱼ by a value proportional to Tconfᵢₘ. The proposed confidence weighted evidence calculation is given by:

$${Tsens}_{ij} = \frac{1}{\vert {N}_{ij} \vert} \times {Σ}_{{S}_{ik} ∈ {N}_{i j}} \text{?} {}^{*} {Tconf}_{ik} \qquad ( 12 )$$

$$where$$

$$\text{?} = \{ \begin{matrix}1 , & if {Observation}_{ik} supports {Observation}_{ij} \\ - 1 , & otherwise .\end{matrix} - 0.15 cm$$

$$\text{?} \text{indicates text missing or illegible when filed}$$

and Nᵢⱼ denotes the set of the neighboring sensor nodes of Sᵢⱼ. The support condition in Eq. 4 is application-specific. As an example, for acoustic sensor observations, the difference between the measurements can be compared to a threshold value to determine if the observations support each other or not.

Reputation of the data source (Trepᵢⱼ): There is a clear interplay between the trust level in an observation and the data source's long-term reputation. Higher reputation of a node leads to higher trust in the node observation. The reputation of a data source evolves in time and is updated by its responsible gateway node. The governing principle of reputation update based on the observation confidence and the evidence of other observations is the following: the reputation reward or penalty must be proportional to the reported confidence. If node Sᵢⱼ has high confidence in its observation (i.e. Tconfᵢⱼ≥confidence threshold) and the observation is substantiated by other nodes (i.e. Tsensᵢⱼ≥evidence threshold), Sᵢⱼ should receive a significant increase ΔRep_{H} in its reputation Trepᵢⱼ. Conversely, if Sᵢⱼ delivers observations with high confidence that are refuted by other nodes, its reputation should also drop significantly. Similarly, rewards and penalties ΔRep_{L} for observations with low confidence should be lower, i.e. ΔRep_{L}<ΔRep_{H}.

$${Trep}_{ij} = \{ \begin{matrix}{Trep}_{ij} + Δ {Rep}_{H} , & high {Tconf}_{ij} , high {Tsens}_{ij} \\ {Trep}_{ij} + Δ {Rep}_{L} , & low {Tconf}_{ij} , high {Tsens}_{ij} \\ {Trep}_{ij} + Δ {Rep}_{H} , & high {Tconf}_{ij} , low {Tsens}_{ij} \\ {Trep}_{ij} + Δ {Rep}_{L} , & low {Tconf}_{ij} , low {Tsens}_{ij}\end{matrix} \qquad ( 13 )$$

Malicious nodes may then be compelled to report erroneous values with low confidence in order to perturb the system. While such nodes will not suffer a significant drop in reputation for each observation, their actions can be countered by: (1) proper design of the function weighting high uncertainty measurements in the trust level calculation; and (2) design of the reputation score update mechanism to penalise repetitive low confidence observations from the same node.

Note that, the data trust block proposed in our architecture is modular and can be adapted for different applications. For example, depending on the spatio-temporal properties of the physical phenomenon being observed by the sensor nodes, spatial and temporal correlation of observations can be incorporated in the trust calculations. Once Trepᵢⱼ and Trustᵢⱼ values are computed for Observationᵢⱼ by the associated gateway Gᵢ, they can be included as part of the transaction that records the occurrence of the observation in the blockchain. This provides an auditable account of the trust estimate of the generated data and the reputation of the data source in the blockchain. FIG. 3 presents the block structure generated by the gateway node Gᵢ. After validation by the other nodes, which maintain the blockchain overlay network, this block is appended to the blockchain.

### Gateway Reputation

This section presents the gateway reputation module, which updates the reputations to be used by the adaptive block validation process to integrate the data trust mechanism to the blockchain layer.

Once a gateway node generates a new block, this block should be validated by validators before being appended to the blockchain. For the proposed trust architecture, the block validation involves: (1) validating the data transactions by checking the public keys of the data sources and their signatures in the transactions; and (2) validating the trust values assigned by the gateway to the observations by recalculating the trust values with the data available in the generated block and on the blockchain. The gateway reputation module tracks the long-term behaviour of gateway nodes and adapts the block validation depending on the reputation of the current gateway node. The proposed reputation module receives frequent updates from the blockchain layer, where each node's honesty in block mining, B(Gᵢ), is reported based on direct and indirect evidence, and used to update the node's reputation score. Our reputation module further integrates the data trust mechanism to the block validation process by validating: (1) the observation trust values assigned by the gateway, and (2) the sensor transactions reported in the block to update the reputation score of the gateway node. External sources of a node's reputation Ext(Gᵢ), which can be imported from other systems, can also be fed into the node's reputation score. In summary, the reputation score, Rep(Gᵢ)∈[Repₘᵢₙ, Repₘₐₓ], of node Gᵢ is based on a function g:

Rep(Gᵢ)=g[T(Gᵢ),B(Gᵢ),Ext(Gᵢ)] (18)

where T(Gᵢ) captures how much other validator nodes trust Gᵢ based on Gᵢ's trust value assignment to the observations.

We propose a reputation update mechanism that considers the validity of sensor transactions and the correctness of the associated trust values. The reputation of the gateway node increases if the generated block is validated, and decreases otherwise.

$$Rep ( {G}_{i} ) = \{ \begin{matrix}min ( {Rep}_{max} , R e p ( {G}_{i} ) + Δ R ) , block is validated \\ max ( {Rep}_{min} , Rep ( {G}_{i} ) - β \cdot Δ R ) , otherwise\end{matrix} \qquad ( 15 )$$

where ΔR is the reputation increase step, and β·ΔR is the reputation reduction step. For β>1, it is harder for the gateway nodes to build reputation than to lose it.

### Blockchain Architecture

Based on Lightweight Scalable Blockchain (LSB) that is optimized for IoT requirements, we propose a private blockchain for our trust architecture with a lightweight block generation mechanism, reputation-based adaptive block validation, and distributed consensus among blockchain nodes.

### Lightweight Block Generation Mechanism

At the blockchain layer, the gateway nodes participate in block generation, block validation, and distributed consensus in a private blockchain network. In a private blockchain, nodes have permissions to participate in the network. Since the gateway nodes are known by the network and have permissions to generate blocks, they do not need to compete for block generation using computationally expensive block mining mechanisms. We propose a lightweight block generation mechanism, where gateways generate blocks in periodic intervals. After receiving all the associated sensor transactions, the gateway validates these transactions and calculates the evidences and the sensor reputations to assign trust values for the sensor observations. Then, it generates a block with transactions containing observation data, the public key and the signature of the data source, the assigned trust value for the observation, and the updated reputation of the data source. The gateway node waits for its turn to multicast the block to the other blockchain nodes for validation. The block generation time periods for the gateways can be adjusted based on the sensor data rate and the latency of data collection and block generation.

### Reputation-Based Adaptive Block Validation

The proposed block validation mechanism adapts the block validation scheme based on the reputation of the block generating node Rep(Gᵢ) and the number of validator nodes Nᵥₐₗ. The integration of trust management in the block verification mechanism improves the block validation and is managed by the gateway reputation module of our architecture.

Depending on the reputation of the block generating node, each validator randomly validates a percentage of the transactions in the block. The idea behind using reputation for adaptive block validation can be explained by

P(successfulattack)=P(attacksucceeds|attack)P(attack) (16)

where higher reputation of a node can be perceived as a lower node attack probability. For a target P(successful attack) threshold, if P(attack) is low, the system can tolerate a higher P(attack succeeds|attack). In terms of block validation, that corresponds to validating a smaller number transactions in a block generated by a gateway with high reputation. Node computers can model the relative effect of the reputation on the percentage of transactions to be validated with a linearly decreasing function.

The percentage of the transactions to be validated also depends on the number of validators. For a fixed probability of invalid block detection target, as the number of validators increases, the percentage of transactions required to be validated by each validator node decreases. Following the adaptive block validation logic, validator nodes validate a percentage of the transactions in a block. Consequently, there is a risk of not detecting invalid transactions in a given block. The probability of not detecting any invalid transactions by Nᵥₐₗ validator nodes given that there are Txᵢₙᵥₐₗ invalid transactions in the block can be calculated as follows:

$$P ( noinval . detection \vert {Tx}_{inval} ) = {( \frac{( \begin{matrix}{Tx}_{total} - {Tx}_{inval} \\ {Tx}_{val}\end{matrix} )}{( \begin{matrix}{Tx}_{total} \\ {Tx}_{val}\end{matrix} )} )}^{{N}_{val}} \qquad ( 17 )$$

where Txₜₒₜₐₗ is the number of transactions in the block and Txᵥₐₗ is the number of transactions to be validated by each validator node. There are

$$( \begin{matrix}{Tx}_{total} \\ {Tx}_{val}\end{matrix} )$$

ways to choose a subset of Txᵥₐₗ transactions to be validated out of which

$$( \begin{matrix}{Tx}_{total} - {Tx}_{inval} \\ {Tx}_{val}\end{matrix} )$$

of them does not include any invalid transactions.

FIG. 20 shows the impact of number of validators and the number of invalid transactions in a block on the probability of not detecting any invalid transactions during block validation. When the number of validators increases, node computers can reduce the percentage of transactions that need to be validated without sacrificing the invalid transaction detection performance. For 20 validators, the probability of not detecting a single invalid transaction among 100 transactions is below 0.08% when each validator validates only 30% of the transactions. If there are more than one invalid transaction, the probability of not detecting any invalid transactions decreases significantly.

The minimum number of validators required to achieve a target probability threshold of not detecting any invalid transactions for a given number of transactions validated by each validator is shown in FIG. 4. As an example, to achieve the 0.1% no detection probability threshold for an invalid transaction, node computers need at least 25 validators, each validating 25 transactions in a block of 100 transactions. The same threshold can also be achieved by 14 validators, each validating 40 transactions.

Based on these observations, we consider an adaptive block validation mechanism, where the Percentage of the Validated Transactions (PVT) decreases with the reputation of the block generating node (Rep) and the number of validator nodes (Nᵥₐₗ) as:

PVT=(γ₀+γ₁Rep)×e^{-δN}^{ᵥₐₗ}×100% (18)

where δ is a controlling parameter determining the effect of Nᵥₐₗ on PVT, and γ₀ and γ₁ are the parameters of an affine function determining the effect of Rep on PVT. For large values of 3, PVT decreases quickly with Nᵥₐₗ and this may result in a lower probability of detection of invalid blocks. For small values of δ, increasing Nᵥₐₗ does not decrease PVT enough, and causes higher number of transactions to be validated than needed. The proposed adaptive block validation scheme can reduce the computational cost of block validation process significantly, and improve the scalability and latency of the proposed trust architecture.

### Distributed Consensus Mechanism

As a result of block validation, a validator either multicasts a “VALID” message to confirm that the block is valid, or an “INVALID TRANSACTION ID” message to notify other nodes about an invalid transaction in the block. If all the validators multicast “VALID” messages, then the block is appended to the blockchain by the nodes. However, if a blockchain node receives “INVALID TRANSACTION ID” messages for a block, it validates the transactions given by the Invalid Transaction IDs. If at least one transaction is found to be invalid, the block is rejected by the node. If all the transactions are verified to be valid, then the block appended to the blockchain. A malicious validator may keep broadcasting “INVALID TRANSACTION ID” messages and try to waste the network resources by forcing all the transactions in the block to be validated. To mitigate such attacks, during the consensus period, each validator is allowed to multicast only one message, either confirming the valid block or containing the transaction ID for only one invalid transaction.

### Performance Evaluation

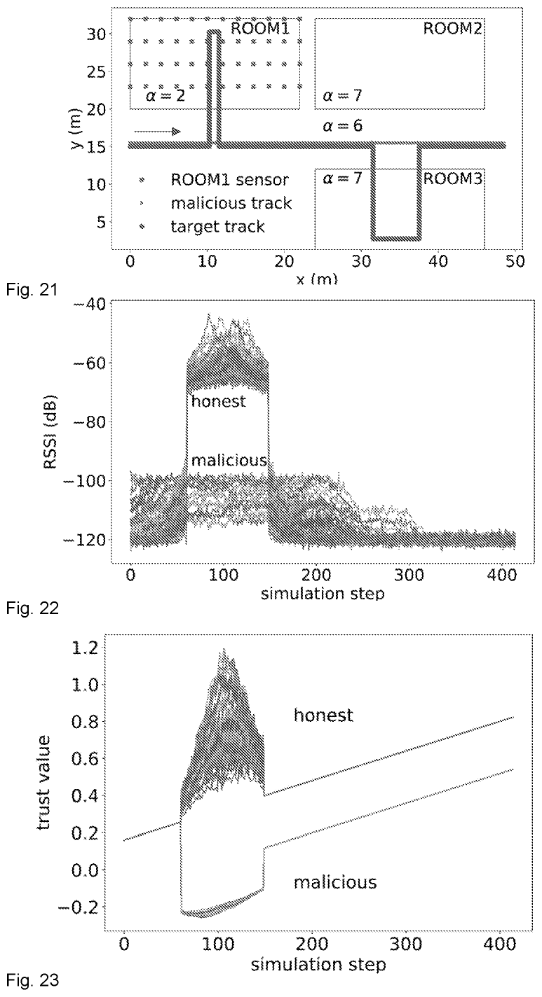

We divide the performance analysis of the architecture into two parts: (1) the performance of the data trust module, and (2) the end-to-end performance of the proposed trust architecture. To illustrate how the proposed architecture works, we consider an indoor target localization application in a smart construction environment, where IoT devices collect data from the construction site to monitor all stages of the construction project. FIG. 21 shows the simulation scenario and the sensor placement in ROOM1, while a target is monitored by sensor nodes placed in ROOM1, ROOM2, and ROOM3. Each room has a gateway node associated with 48 sensor nodes in the room.

### Trust Evaluation at the Data Layer

This section analyzes the data trust module's ability to assign higher trust values to honest nodes and lower trust values to malicious nodes in the presence of malicious observations. Assume that an unauthorized vehicle (target) enters a restricted construction area (ROOM1). The target periodically broadcasts beacons and ROOM1 is monitored by K=48 IoT sensor nodes, which can hear these beacons. The sensors report the RSSI values and the confidence of their observations to the associated gateway by appending their public keys and signing the transactions with their private keys. These RSSI values can be used for target detection and localization in the application layer. Furthermore, we consider that a sensor node may be malicious or malfunctioning and its observation of the target movement may deviate from the true target path. We assume that the honest sensor nodes report RSSI observations for the target track, and malicious sensor nodes report RSSI observations for the malicious track as shown in FIG. 21.

The RSSI(dB) value of a sensor node at an arbitrary distance d from the target can be defined with a log-normal shadowing model as:

RSSI(d)=RSSI(d₀)−10α log₁₀(dd₀)+X_{σ} (19)

where RSSI(d₀) represents the received signal strength at a reference distance d₀, α is the environment-specific pathloss exponent, and X_{δ}:N (0,σ²) is a normal variable, which represents the variation of the received power due to fading. The minimum received RSSI value by the sensor nodes is assumed to be −120 dB. As shown in FIG. 21, the pathloss exponent α changes due to the pathloss environment (e.g. walls, doors, etc.).

We model the confidence of an RSSI observation based on the intuition that the sensor nodes with very high RSSI values would have the maximum confidence in the range of the target. Conversely, sensor nodes with RSSI values below the receiver sensitivity would have a lower constant confidence value. The intuition behind setting a lower confidence value for no target detection is as follows. If honest nodes detect no target, they can report a fixed lower confidence for their observation. A malicious node falsely claiming the absence of the target can therefore not gain a disproportionate advantage over honest nodes by setting high confidence in its false observation. Conversely, setting the target absence confidence to be non-zero avoids a minority of malicious nodes falsely claiming the presence of a target with high confidence and representing a majority view. Observations where the RSSI values are moderate are assigned a confidence based on a linear function as follows:

$$Confidence ( RSSI ) = \{ \begin{matrix}1 , & if RSSI > - 50 \\ 04 , & if RSSI < - 90 \\ \frac{9}{4} + \frac{RSSI}{40} , & otherwise .\end{matrix} \qquad ( 20 )$$

The specific values of the confidence function were derived empirically for our scenario. The simulated RSSI values reported by the sensor nodes are shown in FIG. 22, where 12 of the sensor nodes are malicious and report RSSI values corresponding to the malicious track while the other 36 sensors report true observations of the target track shown in FIG. 22. Since the data sent by the sensor nodes may be inaccurate or tampered with, upon receiving the transactions, the gateway validates the transaction signatures and assigns the trust values shown in FIG. 23 to the transactions using our data trust module. The trust value of the malicious node decreases significantly when the malicious track deviates from the true target track, and can be detected as a malicious observation. For the simulations, we assumed that the sensor nodes are neighbors if the distance between them are less than 10 m and their sensor observations support each other if the observed RSSI difference is less than 25 dB.

Clearly, the performance of the data trust module depends on the ratio of malicious nodes to honest nodes, and the observation confidences. Next, we investigate analytically the maximum number of malicious nodes the data trust module can tolerate as a function of the observation confidences and the total number of nodes when all the sensor nodes associated with a gateway node are assumed to be neighbors. Consider two disjoint sets of nodes, i.e. honest nodes Sₕ and malicious nodes Sₘ, such that |Sₕ|Sₘ|=K and

Trepᵢⱼ=Trepₕ,Tconfᵢⱼ=Tconfₕ for Sᵢⱼ∈Sₕ

Trepᵢⱼ=Trepₘ,Tconfᵢⱼ=Tconfₘ for Sᵢⱼ∈Sₘ

For the worst case scenario of colluding malicious nodes, let us assume that the members of a set share the same evidence value:

Tsensᵢⱼ=Σₖ₌₁^{|S}^{ₕ}^{|-1}Tconfₕ−Σₖ₌₁^{|S}^{ₘ}^{|-1}Tconfₘ for Sᵢⱼ∈Sₕ (21)

Tsensᵢⱼ=Σₖ₌₁^{|S}^{ₘ}^{|-1}Tconfₘ−Σₖ₌₁^{|S}^{ₕ}^{|-1}Tconfₕ for Sᵢⱼ∈Sₘ (22)

Furthermore, malicious nodes can behave like honest nodes to build similar reputations not to get detected before behaving maliciously, i.e. Trepₕ=Trepₘ. Based on these assumptions, the tolerable region, where the data trust module is capable of assigning higher trust values to the honest nodes Trustₕ than the trust values assigned to the malicious nodes Trustₘ is given by:

Trustₕ>Trustₘ

TsensₕTrepₕTconfₕ>TsensₘTrepₘTconfₘ (23)

For Trepₕ=Trepₘ, substituting Eq. 21 and Eq. 22 in Eq. 23:

((|Sₕ|−1)Tconfₕ−|Sₘ|Tconfₘ)Tconfₕ>((|Sₘ|−1)Tconfₘ−(|Sₕ|)Tconfₕ)Tconfₘ (24)

While honest nodes report their true confidence levels, malicious nodes may report higher confidence levels. For Tconfₘ,Tconfₕ>0, Eq. 24 can be stated as:

$$\frac{K + c - 1}{c + 1} > \vert {S}_{m} \vert \qquad ( 25 )$$

where c is the ratio of confidences

$$c = \frac{{Tconf}_{m}}{{Tconf}_{h}} .$$

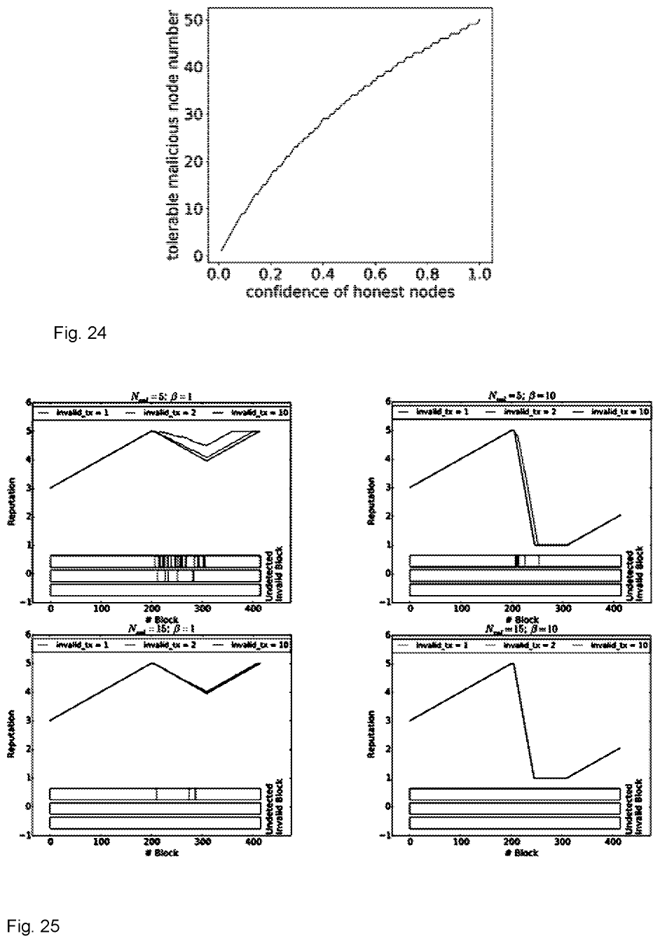

FIG. 24 shows the number of malicious nodes |Sₘ| the data trust module can tolerate as a function of the confidence of the honest nodes Tconfₕ when the malicious nodes report the maximum confidence Tconfₘ=1 and K=100. As the confidence of the honest nodes increases, the tolerable number of malicious nodes increases. When the honest and malicious nodes report the same confidence Tconfₕ=Tconfₘ=1, the tolerable number of malicious nodes reaches its maximum value of 49 out of 100. When half or more of the nodes are malicious, the data trust module can not assign the trust values correctly.

### End-to-End Implementation

For end-to-end performance analysis, we used the ns-3 network simulator with our lightweight blockchain architecture. RSSI measurements were generated according to the simulation scenario shown in FIG. 21, where each room has a gateway associated with 48 sensor nodes. Using our lightweight block generation mechanism, 3 gateways generate blocks every 4.5 s. We also assume that there are some other blockchain nodes, which do not generate any blocks. Together with the gateways, these blockchain nodes participate in the block validation and consensus mechanisms.

The validators follow the adaptive block validation mechanism described above. When Txₜₒₜₐₗ=48, the number of transactions to be validated by each validator can be calculated by

PVT=((4.7/4)−(0.7/4)Rep)×e^{-0.03N}^{ᵥₐₗ}×100% (26)

Txᵥₐₗ=┌Txₜₒₜₐₗ×PVT┐ (27)

where the parameters for Eq. 26 are determined empirically (the optimization of parameters will be considered in future work) such that the probability of not detecting any invalid transactions by Nᵥₐₗ validators given that there is 1 invalid transaction in the block is not ‘high’.

TABLE 1
Number of transactions to be validated

| | Reputation | | | | | P(no invalid detection) | |
|---|---|---|---|---|---|---|---|
| Nᵥₐₗ | 1 | 2 | 3 | 4 | 5 | <0.001 | <0.0001 |
| 5 | 42 | 35 | 27 | 20 | 13 | 36 | 41 |
| | 36 | 30 | 24 | 17 | 11 | 24 | 29 |
| | 31 | 26 | 20 | 15 | 10 | 18 | 23 |

Table 1 shows the number of transactions randomly validated by each validator. Last two columns show the number of transactions to be validated by each validator for a given probability threshold for not detecting an invalid transaction given that there is 1 invalid transaction in the block. For example, when Nᵥₐₗ, =15 and Rep=1, each validator validates 31 transactions randomly chosen out of 48. Whereas, if the gateway has reputation Rep=5, each validator validates only 10 transactions. Note that, in this case, the probability of not detecting an invalid transaction given that there is 1 invalid transaction in the block is ≈0.03. Although this probability may be high, we need to multiply this probability with the attack probability of a gateway node with high reputation to get the probability of a successful attack as in Eq. 16. If the attack probability of a gateway with Rep=5 is less than ≈0.033, the probability of a successful attack becomes less than 0.001. If there is 1 invalid transaction in the block, for Nᵥₐₗ=15, each validator should validate at least 18 transactions so that the probability of not detecting the invalid transaction in the block is less than 0.001. There is a tradeoff between the computational cost of block validation and the probability of a successful attack by a malicious gateway.

### Invalid Block Detection Performance

In this section, a gateway with initial reputation Rep=3 generates 205 valid, 105 invalid, and 105 valid blocks in order, running a single simulation. FIG. 2 shows the reputation evolution of the gateway for ΔR=0.01 and the invalid block detection performance of the adaptive block validation scheme using the number of transactions to be validated given by Eq. 27. The reputation of the gateway increases during the period it generates 200 valid blocks and reaches the maximum reputation Rep=5. Thus, we simulate the worst case scenario for invalid block detection, since the gateway has maximum reputation when it starts generating invalid blocks. The figure shows that for a small number of validators (Nᵥₐₗ=5) and a small reputation reduction step (0.01), the invalid block detection performance is low for the cases where the number of invalid transactions in a block is low (1 or 2).

The invalid block detection performance improves by increasing the number of validators. For Nᵥₐₗ=15, when there is more than 1 invalid transaction in the invalid blocks, all invalid blocks have been detected. Increasing the reputation reduction step also improves the detection performance. However, a steep reputation reduction results in a higher number of transactions to be validated by the validators.

Note that, when there are 10 invalid transactions in the invalid blocks, all invalid blocks have been detected by all of the simulated schemes, as the probability of detecting at least one of the invalid transactions approaches one.

### Delay Analysis

We analyze the latencies caused by the proposed trust architecture by comparing it with a baseline blockchain application without a trust architecture and adaptive block validation.

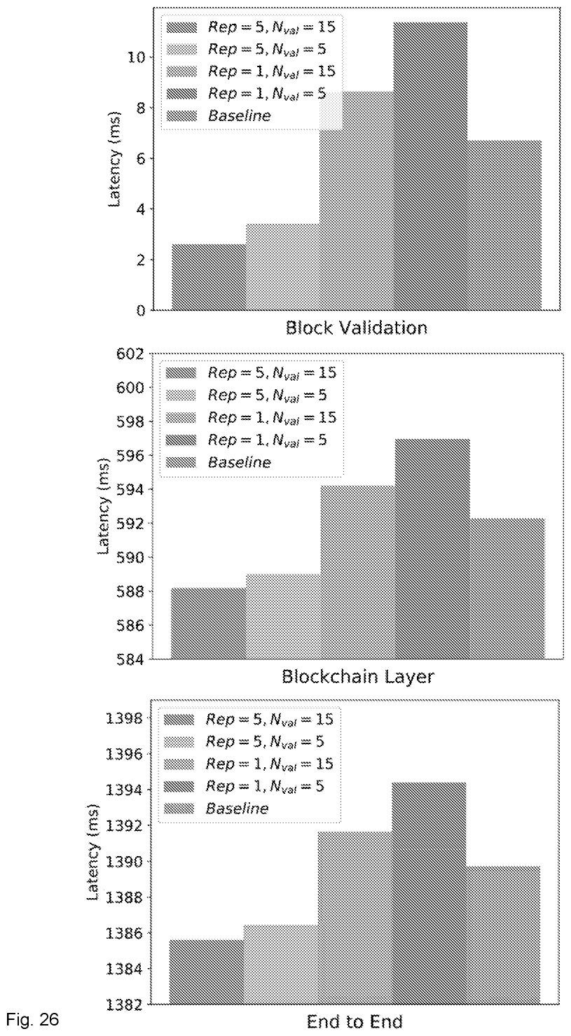

FIG. 26 shows the block validation latency (the time required to validate a block), the blockchain layer latency (the time it takes for a generated block to be appended to the blockchain), and the end-to-end latency (the time it takes for sensor observations to be appended to the blockchain) for the proposed trust architecture and the baseline blockchain application.

In the baseline case, a gateway node creates a block of sensor observations by verifying the signatures of the transactions. In the proposed scheme, a gateway node needs to calculate the trust values for the observations in addition to verifying the transaction signatures.

In the baseline case, blocks are validated by only verifying the signatures of all the transactions. In the proposed scheme, a percentage of the transactions are validated depending on the reputation of the gateway node. However, validation requires checking the signatures and recalculating the trust values.

The block validation, blockchain layer, and end-to-end latencies of the proposed scheme is higher than the baseline when the gateway nodes have low reputation, and lower than the baseline when the gateway nodes have high reputation. However, the difference is relatively low, with the proposed approach adding less than 0.3% end-to-end delay over the baseline, since most of the delay is common for the baseline and the proposed architecture (due to packet transfers from sensor nodes to gateways and among blockchain nodes).

### Security Analysis

This section considers attack scenarios that can be implemented by sensor nodes, blockchain nodes, or external attackers, and the response of the proposed architecture. We assume that the sensor nodes and the gateway nodes are registered to the network during initialization by a trusted entity. Their public keys are published in their profiles and they have secure mechanisms to generate and keep their private keys.

Malicious sensor nodes can try to tamper with their observations. The proposed data trust module uses evidence of other node observations, the reputation of the sensor node, and the reported confidence levels to assign a trust value to the observation. As long as the tampered observation is not supported by other node observations, the observation will be assigned a low trust value depending on the reputation of the sensor node and the confidence of its observation. Furthermore, the reputation of the node is decreased for future observations. In order to increase the probability of a successful attack, malicious sensor nodes may collude to tamper with their observations, such that the tampered observations support each other. For the collusion attack to be successful, the number of malicious nodes should exceed bound given in Eq. 25, which depends on the number of sensor nodes, and the ratio of confidences of malicious and honest nodes.

Malicious gateways: Malicious gateways can generate invalid blocks by tampering transactions, or assigning fake trust values to transactions. During block validation, the validators try to verify the block generated by the malicious node. If the transactions are changed by the gateway, the signatures of the sensor nodes corresponding to the tampered transactions cannot be verified. If the transaction trust values are not assigned according to the architecture, this would also be detected by the validators, as they recompute the trust values for the transactions during block validation. Once the block is invalidated by the validator nodes, the reputation of the gateway node is downgraded. Since the reputation module updates the block validation process depending on the reputation of gateway nodes, the blocks generated by the malicious gateway will be subjected to a stricter validation process. If the malicious node repeats creating invalid blocks, it is isolated from the blockchain network and the data sources connected to that node are associated with a new gateway node.

Colluding blockchain nodes: Malicious blockchain nodes can collude to validate invalid blocks. For a blockchain network with a large number of validators, the success probability of this attack would be very low, as it would require a large number of malicious validators. If the blockchain network has a lower number of validators, the choice of block validating nodes can be randomized to mitigate the collusion of malicious block validating nodes.

Impersonation: An external attacker may try to impersonate a sensor node or a blockchain node. This attack requires the attacker to have access to the private key of the attacked node as all transactions are signed using the private keys of the nodes, whose public keys are known and used for verification of the transactions.

### CONCLUSION

This disclosure provides a layered architecture for improving the end-to-end trust that can be applied to a diverse range of blockchain-based IoT applications. The proposed architecture can also be used for other applications involving physical observations being stored on blockchains (e.g. healthcare, social media analysis, etc.).

At the data layer, the gateways can calculate the trust for sensor observations based on the data they receive from neighboring sensor nodes, the reputation of the sensor node, and the observation confidence. If the neighboring sensor nodes are associated with different gateway nodes, then, the gateway nodes may share the evidence with their neighboring gateway nodes to calculate the observation trust values. This case will be investigated further in our future work.

In the proposed architecture, the computational complexity of calculating the trust values is O(K²), where K is the number of sensor nodes in a cluster with highly correlated observations. The number of spatially proximal nodes is finite and is not large given the practical sensor node densities in real deployments, which reduces the computational cost of calculating trust values within a cluster. When the number of sensor nodes in a cluster is high, nodes can be clustered further for improving the complexity.

We have implemented the data trust and blockchain mechanisms on a custom private blockchain for end-to-end performance analysis. It can also be implemented on major public (e.g. block validation for Ethereum blockchain can be adapted through the Ethereum source code) and private blockchain (e.g. the Hyperledger block validation logic can be adapted through Hyperledger Fabric) platforms.

### Data Processing System

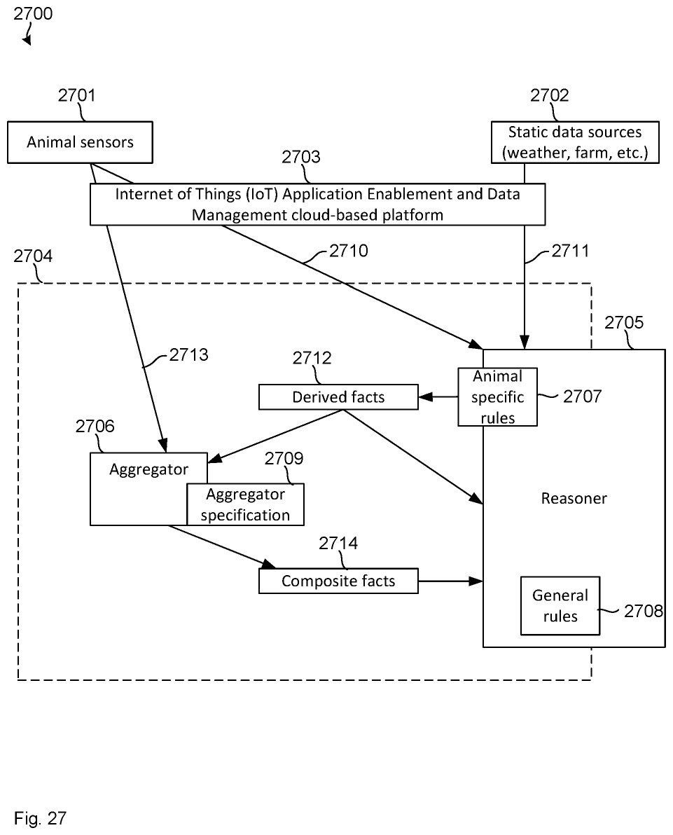

FIG. 27 illustrates a computer architecture 2700 comprises animal sensors 2701 to generate animal data, such as identified behaviour of animals, and static data sources 2702, such as weather sensors, farm sensors etc. The animal sensors 2701 and the static data sources 2702 provide data over an Internet of Things (IoT) Application Enablement and Data Management cloud-based platform, such as Senaps from CSIRO (https://products.csiro.au/senaps/), to a data processing system 2704.

Data processing system 2704 integrates a reasoning engine 2705, such as the SPINdle software as available from https://github.com/NICTA/SPINdle (but other engines can equally be used), and an aggregator 2706. The reasoning engine 2705 has access to animal specific rules 2707, applying to a single animal as well as to general rules 2708, applying over cattle as a whole, such as a group of cattle, a herd of cattle or the cattle of an entire farm.

Aggregator 2706 has access to an aggregation specification 2709, describing how individual variables are to be aggregated (e.g. take the sum, average, etc.). In one example, these rules are defined by legislation, regulations, farm practices, accreditation requirements, etc.

The data processing system 2704 performs the following method steps:

The data processing system 2704 collects 2710 all variables from animals and collects 2711 all static data. The data processing system 2704 uses these variables and applies the animal specific rules 2707 in the reasoner 2705 to obtain derived facts 2712 (i.e. outputs from the animal specific rules).

The data processing system 2704 then takes 2713 animal data and derived facts 2712 for each animal as input to the aggregator 2706 to obtain composite facts 2714 if required in the aggregation spec (e.g. percentage of animals that have been handled carefully). All composite facts 2714, animal data 2710, derived facts 2714, static data 2711 is sent to the reasoner 2705 again to be evaluated against the general rules 2708. The output is posted as the compliance result (possibly posted to the Internet of Things (IoT) Application Enablement and Data Management cloud-based platform again). The last step is the actual compliance check, where the output is compared to a specified requirement.

It is noted that the examples above relate to two layers including the individual animal data 2712/2713 and the composite facts 2714. However, further layers may be included, such that the architecture is individual animal data->aggregated/composite facts->further aggregated/composite facts->final results. It is further noted that the composite facts, also referred to as “composite data” may comprise composite data for a group of animals (such as the herd in total has been on a paddock). In other examples, the composite data comprises composite data over a period of time for an animal, such as “an animal has been drinking at least once in the last 6 hours”, or composite data over a period of time for weather data, such as if it has been raining in the past couple of days, no drinking behaviour is necessary.

The steps before the compliance check, (performed by data processing system 2704) are preprocessing steps to aggregate and prepare raw data from individual animals, to ensure the right information is obtained as requested in the general rules.

The aggregator 2706 allows for a generic aggregation of arrays of values, as specified in the aggregation specification. As such, it is flexible, and allows for various different aggregated outputs.

The architecture disclosed herein, for example architecture 2700 in FIG. 27 provides for robust sensor data processing in the sense that outliers can be handled efficiently. For example, the actual compliance may rely on well-being of the entire group (e.g., herd of animals). However, one of the animals shows non-compliant data. The general rules are flexible enough to specify that a single outlier is not significant for the compliance of the group. In that sense, the solution provides for generally fuzzy processing in the sense that the solution obtains information from individual animals but can specify how to handle uncertainty from the sensor data. For example, in terms of animal specific data, the data processing system 2704 receives only behavioural classification data from the sensors. However, the data processing system 2704 can still make conclusions about the entire group of animals. These conclusions can be more granular than whether each animal individually is compliant, that is, whether the rule for compliance of the entire farm (i.e. group of animals) has been satisfied.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for livestock monitoring, the system comprising:
multiple animal monitoring devices, each configured to:
be mounted on respective animals,
collect accelerometer data of one or more parts of the animals,
classify, by a processor integrated with each of the animal monitoring devices, the accelerometer data into one of multiple animal behaviours, to create behaviour classification data;
one or more gateway devices configured to:
receive the behaviour classification data from one or more of the multiple animal monitoring devices, responsive to the one or more of the multiple animal monitoring devices being within a communication range of the gateway device, and
obtain sensor data in relation to the animals that is measured independent from the animal behaviours; and
a rules engine, located remotely from the animals, configured to determine compliance of the animal behaviours with predetermined rules, wherein the behaviours and sensor data are used as variable values in determining the compliance.

2. The system of claim 1, wherein the one or more gateway devices are configured to store the behaviour classification data and the sensor data on a first blockchain.

3. The system of claim 2, wherein the first blockchain is a private blockchain.

4. The system of claim 2, wherein calculating the score indicative of the reliability of the animal behaviours in light of the sensor data is performed by a smart contract on the first blockchain.

5. The system of claim 1, wherein
the first blockchain is configured to store a hash value of each of multiple blocks; and
the system further comprises a second blockchain that is configured to store the hash values of the first blockchain to establish a cryptographic link to the first blockchain.

6. The system of claim 1, wherein classifying by the processor integrated with each of the animal monitoring devices, the accelerometer data into one of multiple animal behaviours, to create behaviour classification data, is based on a linear classifier.

7. The system of claim 6, wherein the linear classifier comprises a soft-max classifier.

8. The system of claim 1, wherein classifying comprises filtering the accelerometer data using a low-pass filter.

9. The system of claim 1, wherein classifying is based on frequency features of the accelerometer data.

10. The system of claim 1, wherein
the one or more gateway devices are further configured to obtain weather data; and
the weather data is used as variable values in determining compliance by the rules engine.

11. The system of claim 1, wherein each of the multiple animal monitoring devices is further configured to determine compliance, based on data collected by that animal monitoring device, with animal rules.

12. The system of claim 1, wherein each of the multiple animal monitoring devices is further configured to collect sensor data from sensors integrated with that animal monitoring device.

13. The system of claim 12, wherein the sensor data comprises geographic location data from a satellite or terrestrial navigation system.

14. The system of claim 1, wherein the one or more gateway devices are further configured to calculate a score indicative of a reliability of the animal behaviour in light of the sensor data and the rules engine is configured to determine compliance such that the behaviours are related to the score.

15. The system of claim 1, wherein the system further comprises an aggregator configured to receive behaviour classification data for individual animals and output composite data.

16. The system of claim 15, wherein the composite data comprises one or more of:
composite data for a group of animals;
composite data over a period of time for one or more animals; and
composite data over a period for weather data.

17. The system of claim 15, wherein the rules engine is further configured to determine animal data other than behavioural classification data for individual animals, and the aggregator is further configured to receive the animal data other than behavioural classification data to determine the output composite data.

18. The system of claim 17, wherein the rules engine is configured to
access animal specific rules to determine the animal data other than behavioural classification data; and
access general rules to determine compliance based on the output composite data for the group of animals.

19. A method for livestock monitoring, the method comprising:
collecting, by multiple animal monitoring devices mounted on respective animals, accelerometer data of one or more parts of the animals;
classifying, by a processor integrated with each of the animal monitoring devices, the accelerometer data into one of multiple animal behaviours, to create behaviour classification data;
receiving, by a gateway device, the behaviour classification data from one or more of the multiple animal monitoring devices, responsive to the one or more of the multiple animal monitoring devices being within a communication range of the gateway device, and;
obtaining sensor data in relation to the animals that is measured independent from the animal behaviours; and
determining, by a rules engine located remotely from the animals, compliance of the animal behaviours with predetermined rules, wherein the behaviours and sensor data are used as variable values in determining the compliance.

20. A method for livestock monitoring, the method comprising:
responsive to the one or more of the multiple animal monitoring devices being within a communication range, receiving behaviour classification data from multiple animal monitoring devices, the behaviour classification data being indicative of classifications derived from accelerometer data of one or more parts of the animals;
obtaining sensor data in relation to the animals that is measured independent from the animal behaviours; and
determining compliance of the animal behaviours with predetermined rules, wherein the behaviours and sensor data are used as variable values in determining the compliance.
